(19) United States
(12) Patent Application Publication
(10) Pub. No.: US 2025/0252262 A1
(43) Pub. Date: Aug. 7, 2025

(54) DATA PROCESSING METHOD, DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventor: Junqi LI, Shenzhen (CN)

(21) Appl. No.: 19/090,573

(22) Filed: Mar. 26, 2025

Related U.S. Application Data
(63) Continuation of application No. PCT/CN2023/130985, filed on Nov. 10, 2023.

(30) Foreign Application Priority Data
Feb. 27, 2023 (CN) 202310215937.X

(51) Int. Cl. G06F 40/295

(52) U.S. Cl. CPC G06F 40/295

(57) ABSTRACT

A data processing method including obtaining training sample set including sample text, tag entity words in the sample text, and tag entity word pair carrying tag relationship, inputting the training sample set into an initial text recognition model to generate initial node vectors respectively corresponding to nodes including sentence nodes and entity nodes, generating an associated node edge according to the nodes, determining, according to general training parameter of the associated node edge and initial node vectors corresponding to connected nodes connected by the associated node edge, an initial edge vector corresponding to the associated node edge, generating an initial graph structure including initial node vectors and the initial edge vector, and adjusting parameter in the initial text recognition model according to initial node vectors corresponding to every two entity nodes, the tag entity word pair, and the initial graph structure, to obtain text recognition model.

### CROSS-REFERENCE TO RELATED APPLICATIONS

This application is a continuation of International Application No. PCT/CN2023/130985, filed on Nov. 10, 2023, which claims priority to Chinese Patent Application No. 202310215937.X filed on Feb. 27, 2023, the entire contents of which are incorporated herein by reference.

### FIELD OF THE TECHNOLOGY

This application relates to the field of Internet technologies, and in particular, to a data processing method, a device, a computer-readable storage medium, and a computer program product.

### BACKGROUND OF THE DISCLOSURE

In service scenarios such as a text recognition scenario, a text classification scenario, and a text recommendation scenario, it is crucial to accurately recognize an entity relationship between entities in a text.

An entity relationship recognition method in the related art is a machine learning-based method. Therefore, an initial text recognition model needs to be trained based on a training sample set, to obtain a text recognition model applied to a service scenario. In the related art, a training process of an initial text recognition model mainly includes four operations: 1. generating encoded segmented word vectors corresponding to segmented words in a sample text; 2. constructing, based on a plurality of encoded segmented word vectors, an initial graph structure including initial node vectors and an initial edge vector, where the initial edge vector is generated only by using the initial node vectors; 3. inferring the initial edge vector, and generating an entity edge vector of an entity pair by using the inferred edge vector; and 4. predicting a relationship of the entity pair by using the entity edge vector. Apparently, in the related art, because the initial edge vector is generated only by using the initial node vectors, the extensibility of the initial text recognition model is relatively low. In addition, in the related art, each time before a model parameter is adjusted, an initial edge vector needs to be inferred. However, a process of inferring the initial edge vector not only consumes a large quantity of computing resources, but also reduces model parameter update efficiency, thereby reducing efficiency of generating a text recognition model.

### SUMMARY

In accordance with the disclosure, there is provided a data processing method including obtaining a training sample set including a sample text, at least two tag entity words in the sample text, and a tag entity word pair carrying a tag relationship, inputting the training sample set into an initial text recognition model, to generate, based on the initial text recognition model, initial node vectors respectively corresponding to at least two nodes including sentence nodes corresponding to P sample sentences in the sample text and entity nodes respectively corresponding to the at least two tag entity words with P being a positive integer, generating an associated node edge according to the at least two nodes, determining, according to a general training parameter of the associated node edge and initial node vectors respectively corresponding to two connected nodes connected by the associated node edge, an initial edge vector corresponding to the associated node edge, generating an initial graph structure including at least two initial node vectors and the initial edge vector, and adjusting a parameter in the initial text recognition model according to initial node vectors respectively corresponding to every two entity nodes, the tag entity word pair, and the initial graph structure, to obtain a text recognition model configured for determining an entity word pair having the tag relationship in a text. The parameter in the initial text recognition model including the general training parameter.

Also in accordance with the disclosure, there is provided a data processing method including obtaining a text including K target entity words with K being a positive integer greater than 1, inputting the text into a text recognition model, and determining, based on the text recognition model, an entity word pair that is in the K target entity words and that has a tag relationship. The text recognition model is obtained by adjusting a parameter in an initial text recognition model according to initial node vectors respectively corresponding to every two entity nodes, a tag entity word pair, and an initial graph structure including initial node vectors respectively corresponding to at least two nodes and an initial edge vector. At least two initial node vectors are generated by inputting a training sample set including a sample text, at least two tag entity words in the sample text, and a tag entity word pair carrying the tag relationship into the initial text recognition model. The at least two nodes include sentence nodes corresponding to P sample sentences in the sample text and entity nodes respectively corresponding to the at least two tag entity words with P being a positive integer. The initial edge vector is determined according to a general training parameter of an associated node edge and initial node vectors respectively corresponding to two connected nodes connected by the associated node edge. The associated node edge is generated according to the at least two nodes, and the parameter in the initial text recognition model includes the general training parameter.

Also in accordance with the disclosure, there is provided a computer device including a processor and a memory storing a computer program that, when executed by the processor, causes the computer device to obtain a training sample set including a sample text, at least two tag entity words in the sample text, and a tag entity word pair carrying a tag relationship, input the training sample set into an initial text recognition model, to generate, based on the initial text recognition model, initial node vectors respectively corresponding to at least two nodes including sentence nodes corresponding to P sample sentences in the sample text and entity nodes respectively corresponding to the at least two tag entity words with P being a positive integer, generate an associated node edge according to the at least two nodes, determine, according to a general training parameter of the associated node edge and initial node vectors respectively corresponding to two connected nodes connected by the associated node edge, an initial edge vector corresponding to the associated node edge, generate an initial graph structure including at least two initial node vectors and the initial edge vector, and adjust a parameter in the initial text recognition model according to initial node vectors respectively corresponding to every two entity nodes, the tag entity word pair, and the initial graph structure, to obtain a text recognition model configured for determining an entity word pair having the tag relationship in a text. The parameter in the initial text recognition model including the general training parameter

### BRIEF DESCRIPTION OF THE DRAWINGS

To describe the technical solutions in embodiments of this application more clearly, the following briefly describes the accompanying drawings needed for describing the embodiments. Apparently, the accompanying drawings in the following descriptions show some embodiments of this application, and a person of ordinary skill in the art may still derive other accompanying drawings from these accompanying drawings without creative efforts.

FIG. 1 is a schematic diagram of a system architecture according to an embodiment of this application;

FIG. 2 is a first schematic diagram showing a data processing scenario according to an embodiment of this application;

FIG. 3 is a second schematic diagram showing a data processing scenario according to an embodiment of this application;

FIG. 4 is a first schematic flowchart of a data processing method according to an embodiment of this application;

FIG. 5 is a second schematic flowchart of a data processing method according to an embodiment of this application;

FIG. 6 is a third schematic flowchart of a data processing method according to an embodiment of this application;

FIG. 7 is a first schematic structural diagram of a data processing apparatus according to an embodiment of this application;

FIG. 8 is a second schematic structural diagram of a data processing apparatus according to an embodiment of this application; and

FIG. 9 is a schematic structural diagram of a computer device according to an embodiment of this application.

### DESCRIPTION OF EMBODIMENTS

The technical solutions in embodiments of this application are described in the following with reference to the accompanying drawings in the embodiments of this application. Apparently, the described embodiments are merely some rather than all of the embodiments of this application. All other embodiments obtained by a person of ordinary skill in the art based on the embodiments of this application without making creative efforts shall fall within the protection scope of this application.

To facilitate understanding, some nouns are briefly described below:

Artificial intelligence (AI) is a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, inference, and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing (NLP) technology, machine learning (ML)/deep learning, autonomous driving, and intelligent transportation.

A computer vision technology is a science that studies how to use a machine to “see,” and furthermore, is machine vision that a camera and a computer are used for replacing human eyes to perform recognition, measurement, and the like on a target, and further perform graphic processing, so that the computer processes the target into an image more suitable for human eyes to observe, or an image transmitted to an instrument for detection. As a scientific discipline, computer vision studies related theories and technologies and attempts to establish an AI system that can obtain information from images or multidimensional data. The computer vision technologies generally include technologies such as image processing, image recognition, image semantic understanding, image retrieval, optical character recognition (OCR), video processing, video semantic understanding, video content/behavioral recognition, three-dimensional object reconstruction, a 3D technology, virtual reality, augmented reality, simultaneous positioning, map construction, autonomous driving, and intelligent transportation and further include common biometric recognition technologies such as face recognition and fingerprint recognition. In the embodiments of this application, computer vision technologies can be used to construct initial graph structures.

Nature language processing is an important direction in the computer science field and the artificial intelligence field. Nature language processing studies various theories and methods that can implement effective communication between people and computers by using natural languages. Natural language processing is a science that integrates linguistics, computer science, and mathematics. Therefore, research in this field relates to natural languages, that is, daily languages used by people, and therefore, is closely related to linguistic research. The natural language processing technologies generally include technologies such as text processing, semantic understanding, machine translation, robot question-answering, and knowledge graph. In the embodiments of this application, natural language processing may be used to generate encoded segmented word vectors respectively corresponding to segmented words in a text.

Machine learning is a multi-field inter-discipline, and relates to a plurality of disciplines such as the probability theory, statistics, the approximation theory, convex analysis, and the algorithm complexity theory. Machine learning specializes in studying how a computer simulates or implements a human learning behavior to obtain new knowledge or skills, and reorganize an existing knowledge structure, so as to keep improving its performance. Machine learning is the core of AI, is a basic way to make the computer intelligent, and is applied to various fields of AI. Machine learning and deep learning generally include technologies such as an artificial neural network, a belief network, reinforcement learning, transfer learning, inductive learning, and learning from demonstrations. In the embodiments of this application, the text recognition model is an AI model based on machine learning. The text recognition model may be configured to perform recognition processing on a text, to generate an entity pair having a tag relationship.

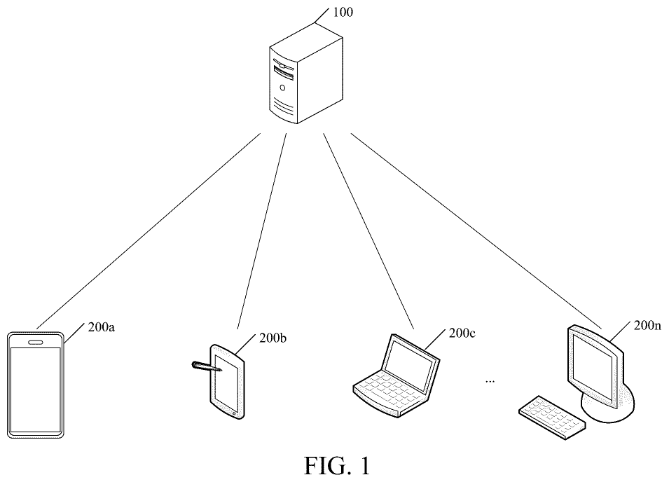

FIG. 1 is a schematic diagram of a system architecture according to an embodiment of this application. As shown in FIG. 1, the system may include a service server 100 and a terminal device cluster. The terminal device cluster may include: a terminal device 200a, a terminal device 200b, a terminal device 200c, . . . , and a terminal device 200n. The system may include one or more terminal devices, and a quantity of terminal devices is not limited in this application.

There may be communication connection in the terminal device cluster, for example, there is communication connection between the terminal device 200a and the terminal device 200b and there is communication connection between the terminal device 200a and the terminal device 200c. In addition, any terminal device in the terminal device cluster may have communication connection with the service server 100. For example, the terminal device 200a has communication connection with the service server 100. The communication connection is not limited to a specific connection manner, and may be direct or indirect connection in a wired communication manner, may be direct or indirect connection in a wireless communication manner, or may be connection in another manner. This is not limited in embodiments of this application herein.

Each terminal device in the terminal device cluster shown in FIG. 1 can be installed with an application client. When the application client is run in each terminal device, the application client can exchange data with the service server 100 shown in FIG. 1, that is, implement the communication connection. The application client may be an application client having a text recognition function, such as a video application, a live broadcast application, a social application, an instant messaging application, a game application, a music application, a shopping application, a novel application, or a browser.

The application client can be an independent client or an embedded sub-client integrated in a client (for example, a social networking client, an education client, or a multimedia client), which is not limited herein. A novel application is used as an example. The service server 100 may be a set including a plurality of servers such as a background server and a data processing server that correspond to the novel application. Therefore, each terminal device may perform data transmission with the service server 100 by using an application client corresponding to the novel application. For example, each terminal device may upload a text to the service server 100 by using the application client of the novel application, so that the service server 100 may determine a text type of the text or recommend a similar text.

In a specific implementation of this application, relevant data such as user information (for example, a training sample set) is involved. In a case that the foregoing embodiments of this application are applied to a specific product or technology, a permission or consent of a user is required, and collection, use, and processing of the relevant data need to comply with relevant laws, regulations, and standards of relevant countries and regions.

For ease of understanding and description below, in embodiments of this application, a terminal device may be selected from the terminal device cluster shown in FIG. 1 as a target terminal device. For example, the terminal device 200a is used as the target terminal device. When receiving a model training instruction for an initial text recognition model, the terminal device 200a may send a model training request for the initial text recognition model to the service server 100 by using an application client. The initial text recognition model is a neural network model configured for recognizing a text and generating an entity relationship between entity words in the text.

After receiving the model training request sent by the terminal device 200a, the service server 100 may obtain a training sample set and the initial text recognition model. The training sample set includes a sample text, marked entity words in the sample text, and a tag entity word pair carrying a tag relationship. In embodiments of this application, the marked entity words are referred to as tag entity words. A type and a source of the sample text are not limited in embodiments of this application, and may be set according to an actual training scenario. The sample text may be a sentence text, a paragraph text, or an article text. The sample text (especially, an article text) may include mention words of the tag entity words, for example, abbreviations or pronouns of the tag entity words. Therefore, the training sample set may further include marked mention words in the sample text. In embodiments of this application, the marked mention words are referred to as tag mention words. The tag relationship and the tag entity word pair are not limited in embodiments of this application, and may be set according to an actual training scenario. For example, the tag relationship is a position relationship. In this case, the tag entity word pair may include a position a and a position b, and the position relationship may indicate that the position a is located at the position b. For another example, the tag relationship is an affiliation relationship. In this case, the tag entity word pair may include an object a and an object b, and the affiliation relationship may indicate that the object a belongs to the object b. A manner in which the service server 100 obtains the training sample set and the initial text recognition model is not limited in embodiments of this application, and may be set according to an actual training scenario. For example, the model training request sent by the terminal device 200a carries the training sample set and/or the initial text recognition model. For example, the service server 100 obtains the training sample set and/or the initial text recognition model from a database, for example, obtains the training sample set and/or the initial text recognition model from a blockchain network.

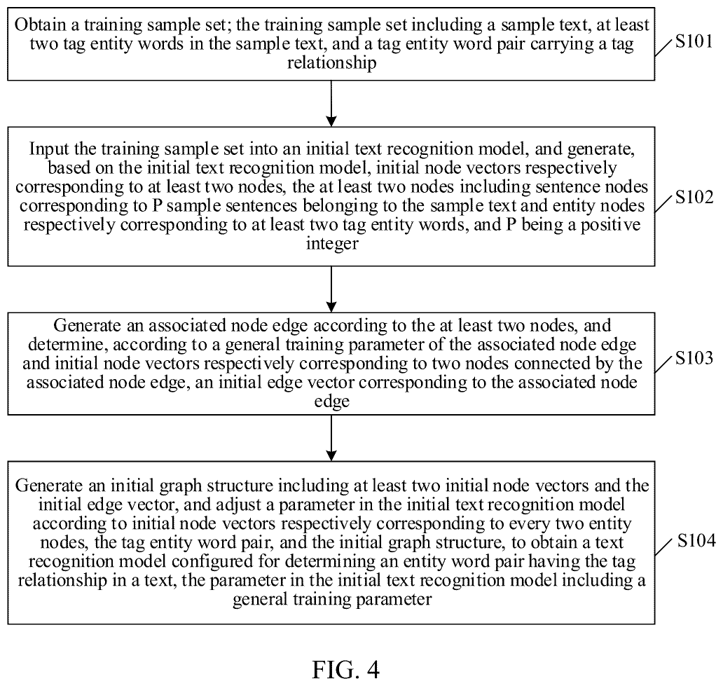

The service server 100 inputs the training sample set into the initial text recognition model. The service server 100 may generate, based on the initial text recognition model, initial node vectors respectively corresponding to at least two nodes. The at least two nodes include sentence nodes corresponding to P sample sentences belonging to the sample text and entity nodes respectively corresponding to at least two tag entity words. P is a positive integer. In some embodiments, if the sample text further includes a tag mention word, the at least two nodes further include a mention node corresponding to the tag mention word. Total quantities of the sample sentences and the tag mention words are not limited in embodiments of this application, and are set according to an actual training scenario. The service server 100 may generate an associated node edge according to the at least two nodes. The associated node edge is generated based on association between elements (that is, the sample sentences, the tag entity words, and the tag mention words) in the sample text. For example, a generation process is not described herein again. Refer to descriptions of operation S103 in the following embodiment corresponding to FIG. 4.

In embodiments of this application, a general training parameter is added for the associated node edge, and the service server 100 may determine, according to the general training parameter of the associated node edge and initial node vectors respectively corresponding to two nodes connected by the associated node edge, an initial edge vector corresponding to the associated node edge. In this disclosure, two nodes connected by a node edge are also referred to as two connected nodes. The service server 100 may generate an initial graph structure including at least two initial node vectors and the initial edge vector, and adjust a parameter in the initial text recognition model according to initial node vectors respectively corresponding to every two entity nodes, the tag entity word pair, and the initial graph structure, to obtain a text recognition model configured for determining an entity word pair having the tag relationship in a text. The parameter in the initial text recognition model includes the general training parameter.

Subsequently, the service server 100 may generate a model training completion message for the text recognition model, and send the model training completion message to the terminal device 200a. After receiving the model training completion message sent by the service server 100, the terminal device 200a may obtain the text recognition model. A manner in which the terminal device 200a obtains the text recognition model is not limited in embodiments of this application, and may be set according to an actual application scenario. For example, the model training completion message carries the text recognition model. For example, the text recognition model is obtained from a database, for example, the text recognition model is obtained from a blockchain network.

In some embodiments, if the terminal device 200a locally stores the initial text recognition model and the training sample set and the terminal device 200a has an offline computing capability, when receiving the model training instruction for the initial text recognition model, the terminal device 200a may locally train the initial text recognition model by using the training sample set, to obtain the text recognition model. A process in which the terminal device 200a locally trains the initial text recognition model by using the training sample set is the same as a process in which the service server 100 trains the initial text recognition model by using the training sample set. Therefore, a specific process in which the terminal device 200a locally trains the initial text recognition model is not described herein again. Refer to the foregoing descriptions.

The service server 100, the terminal device 200a, the terminal device 200b, the terminal device 200c, . . . , and the terminal device 200n may all be blockchain nodes in a blockchain network. Data (for example, the training sample set and the initial text recognition model) described in the entire text may be stored. A storage manner may be a manner in which a blockchain node generates a block according to the data and adds the block to the blockchain for storage.

A blockchain is a new application mode of computer technologies such as distributed data storage, point-to-point transmission, a consensus mechanism, and an encryption algorithm, and is mainly used for sorting data according to a time sequence and encrypting the data into an account book, so that the account book cannot be tampered with and forged, and data can be verified, stored, and updated. Essentially, a blockchain is a decentralized database. Each node in the database stores the same blockchain. A blockchain network may distinguish nodes as a core node, a data node, and a light node. The core node, the data node, and the light node jointly form blockchain nodes. The core node is responsible for consensus on an entire network of a blockchain. That is, the core node is a consensus node in a blockchain network. A process in which transaction data in the blockchain network is written to the account book may be: a data node or a light node in the blockchain network obtains the transaction data, and transmits the transaction data in the blockchain network (that is, the nodes transmit the transaction data one by one) until the consensus node receives the transaction data. The consensus node packages the transaction data into a block, performs consensus on the block, and writes the transaction data to the account book after the consensus is completed. The training sample set and the initial text recognition model are used as an example of the transaction data. After completing consensus on the transaction data, the service server 100 (a blockchain node) generates a block according to the transaction data, and stores the block in the blockchain network. For reading of the transaction data (that is, the training sample set and the initial text recognition model), the blockchain node may obtain the block including the transaction data from the blockchain network, and obtain the transaction data from the block.

A method provided in the embodiments of this application may be performed by a computer device. The computer device includes, but is not limited to, a terminal device or a service server. The service server can be an independent physical server, or a server cluster including multiple physical servers, or a distributed system, and can also be a cloud server that provides basic cloud computing services such as cloud databases, cloud services, cloud computing, cloud functions, cloud storage, network services, cloud communications, middleware services, domain name services, security services, CDN, and big data and artificial intelligence platforms. The terminal device includes but is not limited to a mobile phone, a computer, an intelligent voice interaction device, a smart home appliance, an in-vehicle terminal, an aircraft, and the like. The terminal device and the service server may be connected directly or indirectly through wired or wireless methods, which are not limited in the embodiments of this application.

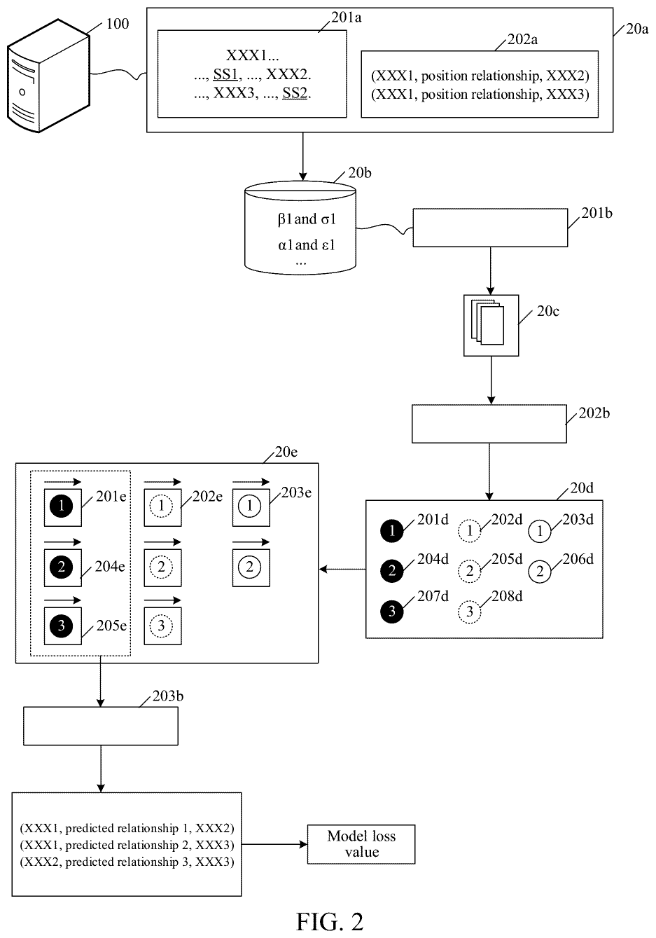

FIG. 2 is a first schematic diagram showing a data processing scenario according to an embodiment of this application. Embodiments of this application may be applied to various scenarios, including but not limited to cloud technologies, artificial intelligence, intelligent transportation, assisted driving, and audio and videos. The embodiments of this application may be applied to service scenarios such as a text recognition scenario, a text search scenario, a text recommendation scenario, and a text classification scenario. The service scenarios are not listed one by one herein. An implementation process of the data processing scenario may be performed in the service server, or may be performed in the terminal device, or may be performed by means of interaction between the terminal device and the service server. This is not limited herein. The terminal device may be any terminal device in the terminal device cluster in the embodiment corresponding to FIG. 1, and the service server may be the service server 100 in the embodiment corresponding to FIG. 1. For ease of description and understanding, embodiments of this application is described by using the service server as an example.

As shown in FIG. 2, a service server 100 may obtain a training sample set 20a and an initial text recognition model 20b. The training sample set 20a may include a sample text 201a and a tag entity word pair 202a having a tag relationship. For ease of description and understanding, for example, the sample text 201a in embodiments of this application includes 3 sample sentences, that is, P is 3. As shown in FIG. 2, a first sample sentence is “XXX1 . . . , “a second sample sentence is” . . . , SS1, . . . , XXX2,“and a third sample sentence is” . . . , XXX3, . . . , SS2.” The sample text 201a may include at least two tag entity words and a tag mention word set. For example, a total quantity of tag entity words shown in FIG. 2 is 3, that is, a tag entity word XXX1, a tag entity word XXX2, and a tag entity word XXX3. For example, the tag mention word set shown in FIG. 2 includes 2 tag mention words, that is, a tag mention word SS1 and a tag mention word SS2. For ease of understanding and description, in FIG. 2, for example, a total quantity of tag entity word pairs 202a shown in FIG. 2 is 2, that is, a first tag entity word pair is (XXX1, position relationship, XXX2), and a second tag entity word pair is (XXX1, position relationship, XXX3). For example, the tag relationship shown in FIG. 2 is a position relationship. The tag entity words in the tag entity word pair 202a all belong to the tag entity words in the sample text 201a.

The service server 100 inputs the training sample set 20a into the initial text recognition model 20b. As shown in FIG. 2, the initial text recognition model 20b may include an initial text encoding layer 201b, an initial graph construction layer 202b, and an initial relationship prediction layer 203b. The service server 100 may generate, by using the initial text encoding layer 201b, encoded segmented word vectors respectively corresponding to at least two segmented words in the sample text 201a, for example, at least two encoded segmented word vectors 20c shown in FIG. 2. A specific process of generating the at least two encoded segmented word vectors 20c is not described herein again. Refer to descriptions of operation S102 in the following embodiment corresponding to FIG. 4. The service server 100 inputs all the at least two encoded segmented word vectors 20c into the initial graph construction layer 202b. Entity nodes respectively corresponding to the 3 tag entity words and sentence nodes corresponding to the 3 sample sentences shown in FIG. 2 may be constructed by using the initial graph construction layer 202b. The 3 entity nodes are respectively 3 black circular nodes shown in FIG. 2 (including an entity node 201d in FIG. 2), and the 3 sentence nodes are respectively 3 dotted-line circular nodes shown in FIG. 2 (including a sentence node 202d in FIG. 2). In addition, the sample text 201a further includes 2 tag mention words (that is, the tag mention word SS1 and the tag mention word SS2 in FIG. 2). Therefore, the service server 100 may further construct, by using the initial graph construction layer 202b, mention nodes respectively corresponding to the 2 tag mention words shown in FIG. 2. The 2 mention nodes are respectively 2 white circular nodes shown in FIG. 2 (including a mention node 203d in FIG. 2).

Therefore, the service server 100 may determine the 3 entity nodes (including the entity node 201d in FIG. 2), the 3 sentence nodes (including the sentence node 202d in FIG. 2), and the 2 mention nodes (including the mention node 203d in FIG. 2) as at least two nodes 20d. According to the at least two encoded segmented word vectors 20c, in the initial graph construction layer 202b, the service server 100 may generate initial node vectors respectively corresponding to the at least two nodes 20d, for example, at least two initial node vectors 20e shown in FIG. 2. The initial node vectors specifically include initial node vectors respectively corresponding to the 3 entity nodes in FIG. 2, for example, an initial node vector 201e corresponding to the entity node 201d, initial node vectors respectively corresponding to the 3 sentence nodes in FIG. 2, for example, an initial node vector 202e corresponding to the sentence node 202d, and initial node vectors respectively corresponding to the 2 mention nodes in FIG. 2, for example, an initial node vector 203e corresponding to the mention node 203d. A specific process of generating the at least two initial node vectors 20e is not described herein again. Refer to descriptions of operation S102 in the following embodiment corresponding to FIG. 4.

In embodiments of this application, the initial text recognition model 20b does not include an inference layer. Therefore, the service server 100 may directly input at least two entity nodes (that is, 3 black circular nodes in FIG. 2, for example, an entity node 201e) to the initial relationship prediction layer 203b. The service server 100 processes, by using the initial relationship prediction layer 203b, initial node vectors respectively corresponding to every two entity nodes, to generate a predicted relationship corresponding to every two entity nodes, that is, a predicted relationship corresponding to every two tag entity words. As shown in FIG. 2, the service server 100 processes the initial node vector 201e and the initial node vector 202e by using the initial relationship prediction layer 203b, to determine a predicted relationship 1 between the tag entity word XXX1 and the tag entity word XXX2. The service server 100 processes the initial node vector 201e and the initial node vector 203e by using the initial relationship prediction layer 203b, to determine a predicted relationship 2 between the tag entity word XXX1 and the tag entity word XXX3. The service server 100 processes the initial node vector 202e and the initial node vector 203e by using the initial relationship prediction layer 203b, to determine a predicted relationship 3 between the tag entity word XXX2 and the tag entity word XXX3. The service server 100 may determine a model loss value of the initial text recognition model 20b according to the predicted relationship 1, the predicted relationship 2, the predicted relationship 3, and the tag entity word pair 202a having the tag relationship.

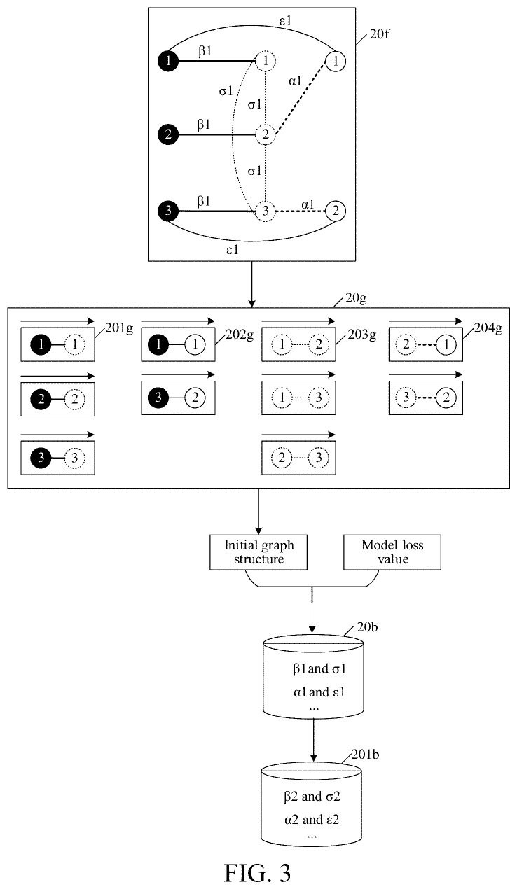

In addition, the service server 100 needs to determine an initial graph structure corresponding to the sample text 201a. Therefore, in the initial graph construction layer 202b, an associated node edge is generated according to the at least two nodes 20d. FIG. 3 is a second schematic diagram showing a data processing scenario according to an embodiment of this application. As shown in FIG. 3, because the tag entity word XXX1 belongs to the first sample sentence, there is a node edge between the entity node (that is, the entity node 201d in FIG. 2) used for representing the tag entity word XXX1 and the sentence node (that is, the sentence node 202d in FIG. 2) used for representing the first sample sentence. A type of the node edge is an entity-sentence edge type. Similarly, because the tag entity word XXX2 belongs to the second sample sentence, there is a node edge between the entity node (that is, the entity node 204d in FIG. 2) used for representing the tag entity word XXX2 and the sentence node (that is, the sentence node 205d in FIG. 2) used for representing the second sample sentence. A type of the node edge is an entity-sentence edge type. Similarly, because the tag entity word XXX3 belongs to the third sample sentence, there is a node edge between the entity node (that is, the entity node 207d in FIG. 2) used for representing the tag entity word XXX3 and the sentence node (that is, the sentence node 208d in FIG. 2) used for representing the third sample sentence. A type of the node edge is an entity-sentence edge type.

The service server 100 constructs a node edge between a sentence node used for representing the first sample sentence and a sentence node used for representing the second sample sentence. A type of the node edge is a sentence-sentence edge type. The service server constructs a node edge between a sentence node used for representing the first sample sentence and a sentence node used for representing the third sample sentence. A type of the node edge is a sentence-sentence edge type. The service server constructs a node edge between a sentence node used for representing the second sample sentence and a sentence node used for representing the third sample sentence. A type of the node edge is a sentence-sentence edge type.

Referring to the sample text 201a in FIG. 2, because the tag mention word SS1 belongs to the second sample sentence, there is a node edge between the mention node (that is, the mention node 203d in FIG. 2) used for representing the tag mention word SS1 and the sentence node (that is, the sentence node 202d in FIG. 2) used for representing the second sample sentence. A type of the node edge is a mention-sentence edge type. Similarly, because the tag mention word SS2 belongs to the third sample sentence, there is a node edge between the mention node (that is, the mention node 206d in FIG. 2) used for representing the tag mention word SS2 and the sentence node (that is, the sentence node 208d in FIG. 2) used for representing the third sample sentence. A type of the node edge is a mention-sentence edge type.

For ease of understanding, in embodiments of this application, for example, the tag mention word SS1 is a mention word of the tag entity word XXX1, and the tag mention word SS2 is a mention word of the tag entity word XXX3. Therefore, the service server 100 constructs a node edge between the mention node used for representing the tag mention word SS1 and the entity node used for representing the tag entity word XXX1. A type of the node edge is a mention-entity edge type. The service server constructs a node edge between the mention node used for representing the tag mention word SS2 and the entity node used for representing the tag entity word XXX3. A type of the node edge is a mention-entity edge type.

Because two tag mention words (that is, the tag mention word SS1 and the tag mention word SS2) in the sample text 201a do not belong to the same sample sentence, there is no node edge between the mention nodes respectively corresponding to the two tag mention words. If there is a node edge between the two mention nodes, a type of the node edge is a mention-mention edge type.

In conclusion, the service server 100 may generate the associated node edge 20f in FIG. 3 by using the initial graph construction layer 202b. In embodiments of this application, to improve model extensibility, a general training parameter is added for each associated node edge. The general training parameter is associated with a type of the node edge. As shown in FIG. 3, a general training parameter β1 is added for a node edge belonging to an entity-sentence edge type. That is, the general training parameter β1 is added for the node edge between the entity node 201d and the sentence node 202d, the general training parameter β1 is added for the node edge between the entity node 204d and the sentence node 205d, and the general training parameter β1 is added for the node edge between the entity node 207d and the sentence node 208d. The service server 100 adds a general training parameter ε1 for a node edge belonging to an entity-mention edge type. That is, the service server adds the general training parameter ε1 for the node edge between the entity node 201d and the mention node 203d, and adds the general training parameter ε1 for the node edge between the entity node 207d and the mention node 206d. The service server 100 adds a general training parameter al for a node edge belonging to a sentence-mention edge type. That is, the service server adds the general training parameter α1 for the node edge between the sentence node 205d and the mention node 203d, and adds the general training parameter α1 for the node edge between the sentence node 208d and the mention node 206d. The service server 100 adds a general training parameter σ1 for a node edge belonging to a sentence-sentence edge type. That is, the service server adds the general training parameter σ1 for the node edge between the sentence node 202d and the sentence node 205d, adds the general training parameter σ1 for the node edge between the sentence node 202d and the sentence node 208d, and adds the general training parameter σ1 for the node edge between the sentence node 208d and the sentence node 205d.

In the initial graph construction layer 202b, the service server 100 may determine, according to the general training parameter of the associated node edge 20f and the initial node vectors respectively corresponding to the two nodes connected by the associated node edge 20f, an initial edge vector corresponding to the associated node edge 20f, for example, an initial edge vector 20g shown in FIG. 3. The initial edge vector includes an initial edge vector 201g of the node edge between the entity node (that is, the entity node 201d in FIG. 2) used for representing the tag entity word XXX1 and the sentence node (that is, the sentence node 202d in FIG. 2) used for representing the first sample sentence, an initial edge vector 202g of the node edge between the entity node used for representing the tag entity word XXX1 and the mention node (that is, the mention node 203d in FIG. 2) used for representing the tag mention word SS1, an initial edge vector 203g of the node edge between the sentence node used for representing the first sample sentence and the sentence node (that is, the sentence node 205d in FIG. 2) used for representing the second sample sentence, and an initial edge vector 204g of the node edge between the sentence node used for representing the second sample sentence and the mention node used for representing the tag mention word SS1.

The service server 100 may generate an initial graph structure including at least two initial node vectors 20e and the initial edge vector 20g, and may adjust the parameter in the initial text recognition model 20b according to the model loss value and the initial graph structure. As shown in FIG. 3, the parameter in the initial text recognition model 20b includes the general training parameter β1, the general training parameter ε1, the general training parameter α1, and the general training parameter σ1. By adjusting the model parameters, the service server 100 may obtain a text recognition model 201b. In this case, the general training parameter β1 is updated to the general training parameter β2, the general training parameter ε1 is updated to the general training parameter ε2, the general training parameter α1 is updated to the general training parameter α2, and the general training parameter σ1 is updated to the general training parameter α2.

As can be learned from the above, in embodiments of this application, a general training parameter is added for a connection edge between nodes, so that the model can better process different graph structures in training and testing phases. In addition, in the process of predicting the relationship between the entity nodes, in embodiments of this application, an inference layer is skipped, and the relationship between the nodes is predicted by combining initial node vectors corresponding to the entity nodes. Therefore, relationship prediction may be implemented without using jump, thereby greatly improving the prediction effect of the entity relationship.

FIG. 4 is a first schematic flowchart of a data processing method according to an embodiment of this application. The data processing method may be performed by a service server (for example, the service server 100 shown in FIG. 1), or may be performed by a terminal device (for example, the terminal device 200a shown in FIG. 1), or may be performed by interaction between a service server and a terminal device. For ease of understanding, in embodiments of this application, for example, the method is performed by a service server. As shown in FIG. 4, the data processing method may include at least the following operation S101 to operation S104.

Operation S101: Obtain a training sample set, the training sample set including a sample text, at least two tag entity words in the sample text, and a tag entity word pair carrying a tag relationship.

For example, a text type and text content of the sample text are not limited in embodiments of this application. For example, the sample text may be an email text, a physical examination text, or a poem text. All data (for example, the sample text) mentioned in embodiments of this application is processed only after the granted permission is obtained.

Entity relationship extraction in related art usually focuses on a single sentence, and only attempts to mine an entity relationship within each sentence. However, in many real scenarios such as medical and financial documents, many relationship are actually included in entity pairs of different sentences in a document, and there is usually a complex relationship between multiple entities in the document. In this case, a plurality of sentences in a document need to be read and inferred. This clearly exceeds a capability range of a sentence-level relationship extraction method. Therefore, it is necessary to push relationship extraction from the sentence level to a document level. In embodiments of this application, not only sentence-level entity relationship extraction can be implemented, but also document-level entity relationship extraction can be implemented. For a specific implementation process, refer to the following operation S102 to operation S104.

The service server obtains the initial text recognition model. A model type of the initial text recognition model is not limited in embodiments of this application, and the initial text recognition model may include any one or more neural networks, such as a convolutional neural network (CNN), a residual network (ResNet), a wide residual network (Wide-ResNet), and a high-resolution network (HRNet).

Operation S102: Input the training sample set into an initial text recognition model, to generate, based on the initial text recognition model, initial node vectors respectively corresponding to at least two nodes; the at least two nodes including sentence nodes corresponding to P sample sentences in the sample text and entity nodes respectively corresponding to the at least two tag entity words; and P being a positive integer.

For example, the initial text recognition model includes an initial text encoding layer and an initial graph construction layer. Segmentation processing is performed on the sample text by using the initial text encoding layer, to obtain at least two segmented words, and vector conversion processing is performed on the at least two segmented words, to generate initial segmented word vectors respectively corresponding to the at least two segmented words. Encoding processing is respectively performed on the at least two initial segmented word vectors, to generate encoded segmented word vectors respectively corresponding to the at least two segmented words, and all the at least two encoded segmented word vectors are inputted into the initial graph construction layer. Entity nodes respectively corresponding to the at least two tag entity words and sentence nodes corresponding to the P sample sentences are constructed by using the initial graph construction layer. The at least two nodes are generated according to the at least two entity nodes and the P sentence nodes, and the initial node vectors respectively corresponding to the at least two nodes are generated according to the at least two encoded segmented word vectors.

The at least two tag entity words include a tag entity word C_{d}, d is a positive integer, and d is less than or equal to a total quantity of the at least two tag entity words. Operation S102 may further include: constructing, if the sample text includes a tag mention word E_{d} corresponding to the tag entity word C_{d}, a mention node corresponding to the tag mention word E_{d}; and a specific process of generating the at least two nodes according to the at least two entity nodes and the P sentence nodes may include: determining the at least two entity nodes, the P sentence nodes, and the mention node corresponding to the tag mention word E_{d} as the at least two nodes.

The at least two nodes include a node F_{g}, g is a positive integer, and g is less than or equal to a total quantity of the at least two nodes. A specific process of generating, according to the at least two encoded segmented word vectors, the initial node vectors respectively corresponding to the at least two nodes may include: if the node F_{g} is used for representing a tag mention word E_{d}, obtaining, from at least two segmented words, a first segmented word included in the tag mention word E_{d}, obtaining, from the at least two encoded segmented word vectors, a first encoded segmented word vector corresponding to the first segmented word, and performing averaging processing on the first encoded segmented word vector, to obtain an initial node vector corresponding to the node F_{g}; if the node F_{g} is used for representing a tag entity word C_{d}, performing averaging processing on an initial node vector corresponding to a tag mention word E_{d}, to obtain an initial node vector corresponding to the node F_{g}; or if the node F_{g} belongs to the P sentence nodes, obtaining, from at least two segmented words, a second segmented word included in a sample sentence corresponding to the node F_{g}, obtaining, from the at least two encoded segmented word vectors, a second encoded segmented word vector corresponding to the second segmented word, and performing averaging processing on the second encoded segmented word vector, to obtain an initial node vector corresponding to the node F_{g}.

A type of the segmented word is not limited in embodiments of this application, and may be a word. For example, if the sample text includes “patient has a fever,” the at least two segmented words may be 4 segmented words, that is, “patient,” “has,” “a,” and “fever.” The segmented word may alternatively be a sub-word. For example, if the sample text includes “advertising is the department of company,” the at least two segmented words may include “ad,” “ver,” “tis,” “ing,” “is,” “the,” “de,” “pa,” “rt,” “ment,” “of,” ¹ “com,” and “pany.” The segmented word may alternatively be a phrase. For example, if the sample text includes “artificial intelligence is a comprehensive technology of computer science,” the at least two segmented words may include “artificial intelligence,” “is,” “a,” “comprehensive technology,” “of,” and “computer science.” Therefore, an attribute of the segmented word may be set according to an actual training scenario. A manner of generating the initial segmented word vector of the segmented word is not limited in embodiments of this application, may be set according to an actual training scenario, and includes, but is not limited to, singular value decomposition based method (SVDBM) and Word2vec. An encoding manner of the initial segmented word vector is not limited in embodiments of this application, may be set according to an actual training scenario, and includes, but is not limited to, embedding from language models (ELMO), bidirectional encoder representation from transformers (BERT), and bidirectional long short-term memory (Bi-LSTM).

In some embodiments, the sample text includes only the sample sentence (one or more) and the at least two tag entity words. Therefore, the at least two nodes include entity nodes respectively corresponding to the at least two tag entity words and a sentence node corresponding to the sample sentence. In some other embodiments, the sample text includes a sample sentence (one or more), at least two tag entity words, and one or more tag mention words. Therefore, the at least two nodes include entity nodes respectively corresponding to the at least two tag entity words, one or more mention nodes, and a sentence node corresponding to the sample sentence. The nodes are in a one-to-one correspondence with the elements (that is, the sample sentences, the tag entity words, and the tag mention words) in the sample text.

As can be seen from the above, the service server may construct 3 different types of nodes: a mention node (nₘ for short) used for representing a tag mention word, an entity node (nₑ for short) used for representing a tag entity word, and a sentence node (nₛ for short) used for representing a sample sentence. The service server calculates a representation form (that is, the initial node vector) of each node as an embedded average value of different elements. Mentions are different mentions of entities, including abbreviations, pronouns, and the like of the entities. The initial node vector of the mention node is an average value of words included in the tag mention word, and may be expressed by the following formula (1).

$$\vec{{n}_{m}} = [ {avg}_{{w}_{i} ∈ m} ( \vec{{w}_{i}} ) ] . \qquad ( 1 )$$

In formula (1), \vec{nₘ} represents an initial node vector of a mention node, a symbol avg represents average processing, m represents a tag mention word, \vec{wᵢ} represents a first segmented word included in the tag mention word, i represents a quantity of first segmented words, and \vec{wᵢ} represents a first encoded segmented word vector. For example, if the tag mention word m is a pronoun “this company,” the first segmented word \vec{wᵢ} may include “this” and “company,” the first encoded segmented word vector \vec{wᵢ} may include an encoded segmented word vector corresponding to “this” and an encoded segmented word vector corresponding to “company,” and the initial node vector \vec{nₘ} is an average value of the encoded segmented word vector corresponding to “this” and the encoded segmented word vector corresponding to “company.”

An entity node represents a unique entity concept, and an initial node vector of the entity node is an average value of initial node vectors of mention nodes associated with the entity, and may be expressed by the following formula (2):

$$\vec{{n}_{e}} = [ {avg}_{{m}_{i} ∈ e} ( \vec{{m}_{i}} ) ] . \qquad ( 2 )$$

In formula (2), \vec{nₑ} represents an initial node vector of an entity node, a symbol avg represents average processing, e represents a tag entity word, mᵢ represents a tag mention word corresponding to the tag entity word (for ease of description, the tag mention word herein is referred to as an associated tag mention word), i represents a total quantity of associated tag mention words, and \vec{mᵢ} represents an initial node vector corresponding to an associated tag mention word. For example, if the tag entity word e is a company, and the sample text includes a company abbreviation name of the company, for example, SS, and includes a pronoun “this company,” the associated tag mention word \vec{mᵢ} may include the name abbreviation “SS” and the mention word “this company,” and the initial node vector mᵢ corresponding to the associated tag mention word may include an initial node vector corresponding to the name abbreviation “SS” and an initial node vector corresponding to the pronoun “this company.” The initial node vector \vec{nₑ} is an average value of the two initial node vectors.

The initial node vector of the sentence node is an average value of second encoded segmented word vectors corresponding to second segmented words in the sample sentence, and may be expressed by the following formula (3):

$$\vec{{n}_{s}} = [ {avg}_{{w}_{i} ∈ s} ( \vec{{w}_{i}} ) ] . \qquad ( 3 )$$

In formula (3), \vec{nₛ} represents an initial node vector of a sentence node, a symbol avg represents average processing, s represents a sample sentence, wᵢ represents a second segmented word included in the sample sentence, i represents a total quantity of second segmented words, and \vec{wᵢ} represents a second encoded segmented word vector.

Operation S103: Generate an associated node edge according to the at least two nodes, and determine, according to a general training parameter of the associated node edge and initial node vectors respectively corresponding to two nodes connected by the associated node edge, an initial edge vector corresponding to the associated node edge.

For example, the at least two entity nodes include an entity node Hᵢ, i is a positive integer, and i is less than or equal to a total quantity of the at least two entity nodes. A first associated sentence node associated with an entity node Hᵢ is obtained from the P sentence nodes, and a first associated node edge including the entity node Hᵢ and the first associated sentence node is generated; where a sample sentence corresponding to the first associated sentence node includes a tag entity word corresponding to the entity node Hᵢ. A second associated node edge is generated according to every two sentence nodes of the P sentence nodes if P is a positive integer greater than 1. The associated node edge is generated according to the first associated node edge and the second associated node edge.

The at least two nodes include J mention nodes, J is a positive integer, and tag mention words corresponding to the J mention nodes belong to the sample text. A specific process of generating the associated node edge according to the first associated node edge and the second associated node edge may include: generating, if the J mention nodes include an associated mention node associated with the entity node Hᵢ, a third associated node edge including the associated mention node and the entity node Hᵢ; where a tag mention word corresponding to the associated mention node is a mention word of a tag entity word corresponding to the entity node Hᵢ; obtaining, from the P sentence nodes, a second associated sentence node associated with the associated mention node, and generating a fourth associated node edge including the associated mention node and the second associated sentence node; where a sample sentence corresponding to the second associated sentence node includes a tag mention word corresponding to the associated mention node; generating, if J is a positive integer greater than 1 and the J mention nodes include an associated mention node pair, a fifth associated node edge including the associated mention node pair; where two tag mention words corresponding to the associated mention node pair are located in the same sample sentence; and determining the first associated node edge, the second associated node edge, the third associated node edge, the fourth associated node edge, and the fifth associated node edge as associated node edges.

For example, a to-be-normalized edge vector (also referred to as a “target edge vector”) corresponding to the associated node edge is determined according to the general training parameter of the associated node edge and the initial node vectors respectively corresponding to the two nodes connected by the associated node edge. The to-be-normalized edge vector corresponding to the associated node edge is normalized, to obtain the initial edge vector corresponding to the associated node edge.

A specific process of determining, according to the general training parameter of the associated node edge and the initial node vectors respectively corresponding to the two nodes connected by the associated node edge, a to-be-normalized edge vector corresponding to the associated node edge may include: determining, according to node types respectively corresponding to the two nodes connected by the associated node edge, the general training parameter and a to-be-processed vector set (also referred to as a “target vector set”) corresponding to the associated node edge; where the to-be-processed vector set includes the initial node vectors respectively corresponding to the two nodes connected by the associated node edge; and the general training parameter includes a general weight parameter and a general scaling parameter; performing weighting processing on the to-be-processed vector set based on the general weight parameter, to obtain a weighted vector set; and concatenating weighted vectors in the weighted vector set, to obtain a to-be-scaled vector (also referred to as a “scaling target vector”), and performing scaling processing on the to-be-scaled vector based on the general scaling parameter, to obtain the to-be-normalized edge vector corresponding to the associated node edge.

A specific process of determining, according to node types respectively corresponding to the two nodes connected by the associated node edge, the general training parameter and a to-be-processed vector set corresponding to the associated node edge may include: determining, if the node types respectively corresponding to the two nodes connected by the associated node edge are different, a compound general training parameter as the general training parameter, and determining the initial node vectors respectively corresponding to the two nodes connected by the associated node edge as the to-be-processed vector set.

The associated node edge includes a first node edge; and two nodes connected by the first node edge include a first node and a second node. A specific process of normalizing the to-be-normalized edge vector corresponding to the associated node edge, to obtain the initial edge vector corresponding to the associated node edge may include: obtaining a second node edge from the associated node edge if a node type corresponding to the first node is different from a node type corresponding to the second node; where if the first node belongs to at least two entity nodes and the second node belongs to the P sentence nodes, two nodes connected by the second node edge include the first node and a third node, and the third node belongs to the P sentence nodes; and if the first node belongs to the mention node set, two nodes connected by the second node edge include the first node and a fourth node, a node type corresponding to the fourth node is the same as the node type corresponding to the second node, and a tag mention word corresponding to a mention node in the mention node set belongs to the sample text; obtaining a to-be-normalized edge vector corresponding to the second node edge from the to-be-normalized edge vector corresponding to the associated node edge; and normalizing, based on the to-be-normalized edge vector corresponding to the second node edge, a to-be-normalized edge vector corresponding to the first node edge, to obtain an initial edge vector corresponding to the first node edge.

A specific process of normalizing, based on the to-be-normalized edge vector corresponding to the second node edge, a to-be-normalized edge vector corresponding to the first node edge, to obtain an initial edge vector corresponding to the first node edge may include: performing activation processing on the to-be-normalized edge vector corresponding to the first node edge, to obtain an activated vector corresponding to the first node edge; and performing activation processing on the to-be-normalized edge vector corresponding to the second node edge, to obtain an activated vector corresponding to the second node edge; performing exponential processing on the activated vector corresponding to the first node edge, to obtain an exponential vector corresponding to the first node edge, and performing exponential processing on the activated vector corresponding to the second node edge, to obtain exponential vectors corresponding to the second node edge; performing summation processing on the exponential vectors corresponding to the second node edge, to obtain a total exponential vector corresponding to the second node edge; and determining a ratio of the exponential vector corresponding to the first node edge to the total exponential vector corresponding to the second node edge as the initial edge vector corresponding to the first node edge.

If a sample sentence includes one tag mention word, in addition to constructing a node edge (that is, the fourth associated node edge) between a sentence node corresponding to the sample sentence and a mention node corresponding to the tag mention word, the service server further determines a tag entity word associated with the tag mention word, and then constructs a node edge (that is, the first associated node edge) between the sentence node corresponding to the sample sentence and an entity node corresponding to the tag entity word.

In conclusion, an undirected edge is constructed between nodes. The rule is derived from natural association between text elements (that is, a mention, an entity, and a sentence). Because it cannot be known in advance whether two entities are related, two entity nodes are not directly connected in embodiments of this application. Connection between nodes is based on predefined document-level interaction. An objective of embodiments of this application is to predict an entity edge representation of every two entity nodes by using an associated node edge, and infer a predicted relationship between every two entity nodes on this basis.

After generating the associated node edge, the service server generates an initial edge vector for each associated node edge. To improve model extensibility, the model parameter includes a general training parameter. The general training parameter refers to that the training parameter is shared for the same edge type. Referring to FIG. 3 and FIG. 2, a second associated node edge exists between the sentence node 202d and the sentence node 205d, and another second associated node edge exists between the sentence node 202d and the sentence node 208d. However, the initial edge vectors respectively corresponding to the two second associated node edges are both generated by using the general training parameter σ1 corresponding to the sentence-sentence edge type. Similarly, a first associated node edge exists between the entity node 201d and the sentence node 202d, and another first associated node edge exists between the entity node 204d and the sentence node 205d. However, the initial edge vectors respectively corresponding to the two first associated node edges are both generated by using the general training parameter β1 corresponding to the entity-sentence edge type.

In embodiments of this application, 5 types of node edges may be provided: an entity-sentence edge (ES edge for short), a mention-entity edge (ME edge for short), a mention-sentence edge (MS edge for short), a mention-mention edge (MM edge for short), and a sentence-sentence edge (SS edge for short). Correspondingly, the types are respectively an entity-sentence edge type (ES edge type for short), a mention-entity edge type (ME edge type for short), a mention-sentence edge type (MS edge type for short), a mention-mention edge type (MM edge type for short), and a sentence-sentence edge type (SS edge type for short). General training parameters respectively corresponding to different edge types may be the same or may be different, and may be determined according to an actual training scenario.

Therefore, the service server first determines the edge type of the associated node edge, and then obtains the general training parameter associated with the edge type (that is, the node types respectively corresponding to the two nodes connected by the associated node edge). In this case, there are 3 cases. Case 1: If the node types respectively corresponding to the two nodes connected by the associated node edge are different, the service server determines a compound general training parameter as the general training parameter, and determines the initial node vectors respectively corresponding to the two nodes connected by the associated node edge as the to-be-processed vector set. Case 1 may be further divided into the following 3 cases.

Case 1.1: If node types respectively corresponding to the two nodes connected by the associated node edge are a mention node type and a sentence node type, that is, the edge type is the MS edge type, the service server refers to the associated node edge as an MS node edge. A to-be-processed vector set of the MS node edge includes an initial node vector of the mention node connected by the MS node edge and an initial node vector of the sentence node connected by the MS node edge. In this case, the compound general training parameter is a general training parameter for the MS edge type, for example, the general training parameter al shown in FIG. 3. A to-be-normalized edge vector of the MS node edge may be described by the following formula (4):

$$\vec{{xx}_{{M}_{i} {S}_{j}}} = {a}_{ms} ( {W}_{ms} \times \vec{{n}_{m}} ; {W}_{ms} \times \vec{{n}_{s}} ) ; {S}_{j} ∈ {M}_{i} S . \qquad ( 4 )$$

In formula (4), Mᵢ represents an i^{th} mention node, Sⱼ represents a j^{th} sentence node connected to a mention node Mᵢ, MᵢS represents a sentence node set that is connected to a mention node Mᵢ and whose node type is a sentence node type, \vec{nₘ} represents an initial node vector of the mention node Mᵢ, \vec{nₛ} represents an initial node vector of the sentence node Sⱼ, Wₘₛ represents a general weight parameter in the general training parameter α1, aₘₛ represents a general scaling parameter in the general training parameter α1, and

$$\vec{{xx}_{{M}_{i} {S}_{j}}}$$

represents a to-be-normalized edge vector of a node edge MᵢSⱼ.

The service server normalizes the to-be-normalized edge vector corresponding to the MS node edge, to obtain an initial edge vector corresponding to the MS node edge. A specific process may be implemented by the following formula (5):

$$\vec{{x}_{{M}_{i} {S}_{j}}} = \frac{exp ( Leaky ReLU ( \vec{{xx}_{{M}_{i} {S}_{j}}} ) )}{{\sum }_{K ∈ {M}_{i} S} exp ( Leaky ReLU ( \vec{{xx}_{{M}_{i} {S}_{K}}} ) )} . \qquad ( 5 )$$

In formula (5), Leaky ReLU represents an activation function, exp represents an exponential function, Σ represents a summation symbol, K represents any sentence node in a sentence node set MᵢS, and

$$\vec{{x}_{{M}_{i} {S}_{j}}}$$

represents an initial edge vector of a node edge MᵢSⱼ.

Case 1.2: If node types respectively corresponding to the two nodes connected by the associated node edge are a mention node type and an entity node type, that is, the edge type is the ME edge type, the service server refers to the associated node edge as an ME node edge. A to-be-processed vector set of the ME node edge includes an initial node vector of the mention node connected by the ME node edge and an initial node vector of the entity node connected by the ME node edge. In this case, the compound general training parameter is a general training parameter for the ME edge type, for example, the general training parameter ε1 shown in FIG. 3. A to-be-normalized edge vector of the ME node edge may be described by the following formula (6):

$$\vec{{xx}_{{M}_{i} {E}_{j}}} = {a}_{me} ( {W}_{me} \times \vec{{n}_{m}} ; {W}_{me} \times \vec{{n}_{e}} ) ; {E}_{j} ∈ {M}_{i} E . \qquad ( 6 )$$

In formula (6), Mᵢ represents an it^{h} mention node, Eⱼ represents a j^{th} entity node connected to a mention node Mᵢ, MᵢE represents an entity node set that is connected to the mention node Mᵢ and whose node type is an entity node type, \vec{nₘ} represents an initial node vector of the mention node Mᵢ, \vec{nₑ} represents an initial node vector of the entity node Eⱼ, Wₘₑ represents a general weight parameter in the general training parameter F1, aₘₑrepresents a general scaling parameter in the general training parameter ε1, and aₘₑ

$$\vec{{xx}_{{M}_{i} {E}_{j}}}$$

represents a to-be-normalized edge vector of a node edge MᵢEⱼ.

The service server normalizes the to-be-normalized edge vector corresponding to the ME node edge, to obtain an initial edge vector corresponding to the ME node edge. A specific process may be implemented by the following formula (7):

$$\vec{{x}_{{M}_{i} {E}_{j}}} = \frac{exp ( Leaky ReLU ( \vec{{xx}_{{M}_{i} {E}_{j}}} ) )}{{\sum }_{K ∈ {M}_{i} E} exp ( Leaky ReLU ( \vec{{xx}_{{M}_{i} {E}_{K}}} ) )} . \qquad ( 7 )$$

In formula (7), K represents any entity node in an entity node set MᵢE, and

$$\vec{{x}_{{M}_{i} {E}_{j}}}$$

represents an initial edge vector of a node edge MᵢEⱼ.

Case 1.3: If node types respectively corresponding to the two nodes connected by the associated node edge are a sentence node type and an entity node type, that is, the edge type is the ES edge type, the service server refers to the associated node edge as an ES node edge. A to-be-processed vector set of the ES node edge includes an initial node vector of the sentence node connected by the ES node edge and an initial node vector of the entity node connected by the ES node edge. In this case, the compound general training parameter is a general training parameter for the ES edge type, for example, the general training parameter β1 shown in FIG. 3. A to-be-normalized edge vector of the ES node edge may be described by the following formula (8):

$$\vec{{xx}_{{E}_{i} {S}_{j}}} = {a}_{es} ( {W}_{es} \times \vec{{n}_{e}} ; {W}_{es} \times \vec{{n}_{s}} ) ; {S}_{j} ∈ {E}_{i} S . \qquad ( 8 )$$

In formula (8), Eᵢ represents an i^{th} entity node, Sⱼ represents a j^{th} sentence node connected to an entity node Eᵢ, EᵢS represents a sentence node set that is connected to the entity node Eᵢ and whose node type is a sentence node type, \vec{nₑ} represents an initial node vector of the entity node Eᵢ, \vec{nₛ} represents an initial node vector of the sentence node Sⱼ, Wₑₛ represents a general weight parameter in the general training parameter β1, aₑₛ represents a general scaling parameter in the general training parameter β1, and

$$\vec{{xx}_{{E}_{i} {S}_{j}}}$$

represents a to-be-normalized edge vector of a node edge EᵢSⱼ.

The service server normalizes the to-be-normalized edge vector corresponding to the ES node edge, to obtain an initial edge vector corresponding to the ES node edge. A specific process may be implemented by the following formula (9):

$$\vec{{x}_{{E}_{i} {S}_{j}}} = \frac{exp ( Leaky ReLU ( \vec{{xx}_{{E}_{i} {S}_{j}}} ) )}{{\sum }_{K ∈ {E}_{i} S} exp ( Leaky ReLU ( \vec{{xx}_{{E}_{i} {S}_{k}}} ) )} . \qquad ( 9 )$$

In formula (9), K represents any sentence node in a sentence node set EᵢS, and

$$\vec{{x}_{{E}_{i} {S}_{j}}}$$

represents an initial edge vector of a node edge EᵢSⱼ.

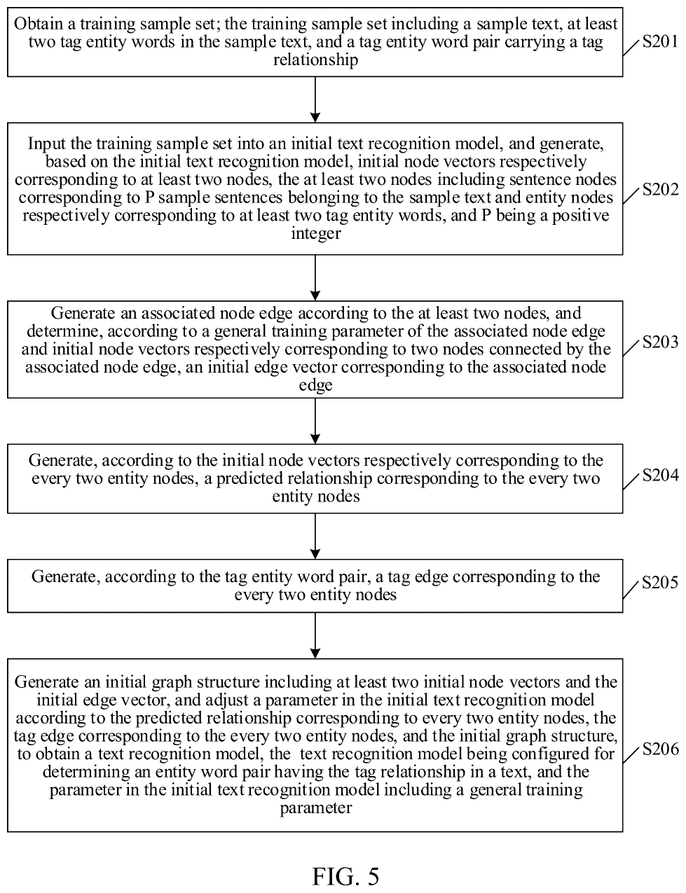

The foregoing describes the case in which the node types respectively corresponding to the two nodes connected by the associated node edge are different. In this operation, the case in which the node types respectively corresponding to the two nodes connected by the associated node edge are the same is not described. Refer to descriptions of operation S203 in the embodiment corresponding to FIG. 5 below.

Operation S104: Generate an initial graph structure including at least two initial node vectors and the initial edge vector, and adjust a parameter in the initial text recognition model according to initial node vectors respectively corresponding to every two entity nodes, the tag entity word pair, and the initial graph structure, to obtain a text recognition model configured for determining an entity word pair having the tag relationship in a text; the parameter in the initial text recognition model including the general training parameter.

For example, according to the tag entity word pair having the tag relationship, the service server may determine a tag of a corresponding entity node edge as a positive sample tag. Referring to FIG. 2, because the tag entity word pair 202a includes two tag entity word pairs, and the first tag entity word pair is (XXX1, XXX2), a tag edge between an entity node corresponding to the tag entity word XXX1 and an entity node corresponding to the tag entity word XXX2 may be determined as a positive sample tag edge according to the position relationship. Therefore, the tag edge between the entity node corresponding to the tag entity word XXX1 and the entity node corresponding to the tag entity word XXX3 may be determined as a positive sample tag edge according to the position relationship. To improve the accuracy of relationship prediction, the service server determines a tag edge between an entity node corresponding to the tag entity word XXX2 and an entity node corresponding to the tag entity word XXX3 as a negative sample tag edge. In this way, each node edge has a tag. Therefore, when initial node vectors respectively corresponding to every two entity nodes are obtained, a loss value of a corresponding node edge may be determined with reference to a tag of the node edge. A model loss value may be determined according to loss values of all node edges. The service server adjusts the parameter in the initial text recognition model according to the model loss value and the initial graph structure, to obtain the text recognition model.

As can be seen from operation S103 and operation S104, in embodiments of this application, by introducing an entirely new updatable weight variable, that is, a general training parameter, for the associated node edge, extensibility of a trained model is greatly improved. In addition, by means of feature fusion and negative samples of the entity nodes, relationship prediction of the entity nodes may be implemented without jump. Therefore, an effect of entity relationship prediction can be greatly improved.

In embodiments of this application, the adjustable general training parameter is introduced for the associated node edge. Therefore, the extensibility of the initial text recognition model can be improved, that is, a processing effect of the initial text recognition model for different graph structures can be improved. In addition, in embodiments of this application, because the initial edge vector does not need to be inferred, waste of computing resources can be reduced. In addition, because inferring the initial edge vector is avoided, a model parameter can be quickly updated, thereby improving efficiency of generating a text recognition model.

FIG. 5 is a second schematic flowchart of a data processing method according to an embodiment of this application. The method may be performed by a service server (for example, the service server 100 shown in FIG. 1), or may be performed by a terminal device (for example, the terminal device 200a shown in FIG. 1), or may be performed by interaction between a service server and a terminal device. For ease of understanding, in embodiments of this application, for example, the method is performed by a service server. As shown in FIG. 5, the method may include at least the following operations:

Operation S201: Obtain a training sample set, the training sample set including a sample text, at least two tag entity words in the sample text, and a tag entity word pair carrying a tag relationship.

Operation S202: Input the training sample set into an initial text recognition model, to generate, based on the initial text recognition model, initial node vectors respectively corresponding to at least two nodes; the at least two nodes including sentence nodes corresponding to P sample sentences in the sample text and entity nodes respectively corresponding to the at least two tag entity words; and P being a positive integer.

For a specific implementation process of operation S201 and operation S202, refer to operation S101 and operation S102 in the corresponding embodiment in FIG. 4, and details are not described herein.

Operation S203: Generate an associated node edge according to the at least two nodes, and determine, according to a general training parameter of the associated node edge and initial node vectors respectively corresponding to two nodes connected by the associated node edge, an initial edge vector corresponding to the associated node edge.

For example, if the node types respectively corresponding to the two nodes connected by the associated node edge are the same and the two nodes connected by the associated node edge both belong to P sentence nodes, a general sentence training parameter is determined as the general training parameter, and the initial node vectors respectively corresponding to the two nodes connected by the associated node edge and a distance vector between the two nodes connected by the associated node edge are determined as the to-be-processed vector set. If the node types respectively corresponding to the two nodes connected by the associated node edge are the same and the two nodes connected by the associated node edge both belong to a mention node set, a general mention training parameter is determined as the general training parameter, and the initial node vectors respectively corresponding to the two nodes connected by the associated node edge, context vectors of the two nodes connected by the associated node edge, and a distance vector between the two nodes connected by the associated node edge are determined as the to-be-processed vector set; where a tag mention word corresponding to a mention node in the mention node set belongs to the sample text.

For example, the associated node edge includes a third node edge; and two nodes connected by the third node edge include a fifth node and a sixth node. A specific process of normalizing the to-be-normalized edge vector corresponding to the associated node edge, to obtain the initial edge vector corresponding to the associated node edge may include: obtaining a fourth node edge and a fifth node edge from the associated node edge if a node type corresponding to the fifth node is the same as a node type corresponding to the sixth node; where if the fifth node and the sixth node both belong to the P sentence nodes, two nodes connected by the fourth node edge include the fifth node and a seventh node, and two nodes connected by the fifth node edge include the sixth node and an eighth node, and the seventh node and the eighth node both belong to the P sentence nodes; and if the fifth node and the sixth node both belong to the mention node set, two nodes connected by the fourth node edge include the fifth node and a ninth node, and two nodes connected by the fifth node edge include the sixth node and a tenth node, the ninth node and the tenth node both belong to the mention node set, and a tag mention word corresponding to a mention node in the mention node set belongs to the sample text; obtaining, from the to-be-normalized edge vector corresponding to the associated node edge, a to-be-normalized edge vector corresponding to the fourth node edge and a to-be-normalized edge vector corresponding to the fifth node edge; normalizing, based on the to-be-normalized edge vector corresponding to the fourth node edge, a to-be-normalized edge vector corresponding to the third node edge, to obtain a first initial edge vector corresponding to the third node edge; normalizing, based on the to-be-normalized edge vector corresponding to the fifth node edge, a to-be-normalized edge vector corresponding to the third node edge, to obtain a second initial edge vector corresponding to the third node edge; and determining the first initial edge vector and the second initial edge vector as initial edge vectors corresponding to the third node edge.

In operation S103 in the foregoing embodiment corresponding to FIG. 4, a case in which the node types respectively corresponding to the two nodes connected by the associated node edge are different is described, that is, the case 1. In this operation, a case in which the node types respectively corresponding to the two nodes connected by the associated node edge are the same is described, that is, a case 2 and a case 3.

Case 2: If node types respectively corresponding to the two nodes connected by the associated node edge are both a sentence node type, that is, the edge type is the SS edge type, the service server refers to the associated node edge as an SS node edge. A to-be-processed vector set of the SS node edge includes initial node vectors respectively corresponding to the two sentence nodes connected by the SS node edge and a distance vector between the two sentence nodes. In this case, the general sentence training parameter is a general training parameter for the SS edge type, for example, the general training parameter al shown in FIG. 3. A to-be-normalized edge vector of the SS node edge may be described by the following formula (10):

$$\vec{{xx}_{{S}_{i} {S}_{j}}} = {a}_{ss} ( {W}_{ss} \times \vec{{n}_{{S}_{i}}} ; {W}_{ss} \times \vec{{n}_{{S}_{j}}} ; {W}_{ss} \times {d}_{{S}_{i} , {S}_{j}} ) ; {S}_{j} ∈ {S}_{i} S . \qquad ( 10 )$$

In formula (10), Sᵢ represents an i^{th} sentence node, Sⱼ represents a j^{th} sentence node connected to the sentence node Sᵢ, SᵢS represents a sentence node set that is connected to the sentence node Sᵢ and whose node type is a sentence node type,

$$\vec{{n}_{{s}_{i}}}$$

represents an initial node vector of the sentence node Sᵢ,

$$\vec{{n}_{{s}_{j}}}$$

represents an initial node vector of the sentence node Sⱼ, Wₛₛ represents a general weight parameter in the general training parameter σ1, aₛₛ represents a general scaling parameter in the general training parameter σ1,

$$\vec{{xx}_{{S}_{i} {S}_{j}}}$$

represents a to-be-normalized edge vector of a node edge SᵢSⱼ, and dₛ_{ᵢ}_{,s}_{ⱼ} represents a distance between the sentence node Sᵢ and the sentence node Sⱼ.

The service server normalizes the to-be-normalized edge vector corresponding to the SS node edge, to obtain an initial edge vector corresponding to the SS node edge. A specific process may be implemented by the following formula (11):

$$\vec{{x}_{{S}_{i} {S}_{j}}} = \frac{exp ( Leaky ReLU ( \vec{{xx}_{{S}_{i} {S}_{j}}} ) )}{{\sum }_{K ∈ {S}_{i} S} exp ( Leaky ReLU ( \vec{{xx}_{{S}_{i} {S}_{K}}} ) )} . \qquad ( 11 )$$

In formula (11), K represents any sentence node in a sentence node set SᵢS, and

$$\vec{{x}_{{S}_{i} {S}_{j}}}$$

represents an initial edge vector of a node edge SᵢSⱼ.

Case 3: If node types respectively corresponding to the two nodes connected by the associated node edge are both a mention node type, that is, the edge type is the MM edge type, the service server refers to the associated node edge as an MM node edge. A to-be-processed vector set of the MM node edge includes initial node vectors respectively corresponding to two mention nodes connected by the MM node edge, context vectors of the two mention nodes connected by the MM node edge, and a distance vector between the two mention nodes. In this case, the general mention training parameter is a general training parameter for the MM edge type. A to-be-normalized edge vector of the MM node edge may be described by the following formula (12):

$$\vec{{{XX}_{{M}_{i} {M}_{j}}}^{}} = {a}_{m m} ( {W}_{m m} \times \vec{{n}_{{M}_{i}}} ; {W}_{m m} \times \vec{{n}_{{M}_{j}}} ; {W}_{m m} \times \vec{{C}_{{M}_{i} , {M}_{j}}} ; {W}_{m m} \times {d}_{{M}_{i} , {M}_{j}} ) ; {M}_{j} ∈ {M}_{i} M . \qquad ( 12 )$$

In formula (12), Mᵢ represents an i^{th} mention node, Mⱼ represents a j^{th} mention node connected to the mention node Mᵢ, MᵢM represents a mention node set that is connected to the mention node Mᵢ and whose node type is a mention node type,

$$\vec{{n}_{{M}_{i}}}$$

represents an initial node vector of the mention node Mᵢ,

$$\vec{{n}_{{M}_{j}}}$$

represents an initial node vector of the mention node Mⱼ, Wₘₘ represents a general weight parameter in the general mention training parameter, aₘₘ represents a general scaling parameter in the general mention training parameter,

$$\vec{{XX}_{{M}_{i} {M}_{j}}}$$

represents a to-be-normalized edge vector of a node edge MᵢMⱼ, d_{M}_{ᵢ}_{,M}_{ⱼ} represents a distance between the mention node Mᵢ and the mention node Mⱼ, and

$$\vec{{C}_{{M}_{i} , {M}_{j}}}$$

represents context vectors of the mention node Mᵢ and the mention node Mⱼ and may be determined by the following formula (13):

$${A}_{f , g} = \frac{exp ( \vec{{n}_{{m}_{f}}^{T}} \vec{{y}_{g}} )}{{\sum }_{z ∈ [ 1 , r ] , z ∉ {m}_{f}} exp ( \vec{{n}_{{m}_{f}}^{T}} \vec{{y}_{z}} )} \qquad ( 13 )$$

$${A}_{g} = \frac{{A}_{1 , g} + {A}_{2 , g}}{2}$$

$$\vec{{C}_{{M}_{i} , {M}_{j}}} = {H}^{T} B .$$

f in formula (13) is equal to i and j in formula (12), m_{f} represents the two mention nodes (that is, the mention node Mᵢ and the mention node Mⱼ) in formula (12), a symbol T indicates transposition processing,

$$\vec{{n}_{{m}_{f}}^{T}}$$

represents a transposed initial node vector of the mention node m_{f}, y_{z} represents a remaining segmented word other than segmented words corresponding to the two mention nodes in the sample sentence to which the two mention nodes belong, r represents a quantity of remaining segmented words, \vec{y_{z}} represents an encoded segmented word vector of a remaining segmented word, y_{g} represents a g^{th} remaining segmented word, and \vec{y_{g}} represents an encoded segmented word vector corresponding to the g^{th} remaining segmented word. A_{1, g}, represents an attention weight of the g^{th} remaining segmented word for the first mention node, A_{2, g} represents an attention weight of the g^{th} remaining segmented word for the second mention node, and A_{g} represents an attention weight of the g^{th} remaining segmented word for the two mention nodes. H^{T} represents a matrix vector of the sample sentence to which the two mention nodes belong, and B represents an attention weight matrix.

The service server normalizes the to-be-normalized edge vector corresponding to the MM node edge, to obtain an initial edge vector corresponding to the MM node edge. A specific process may be implemented by the following formula (14):

$$\vec{{x}_{{M}_{i} {M}_{j}}} = \frac{exp ( Leaky Re LU ( \vec{{XX}_{{M}_{i} {M}_{j}}} ) )}{{\sum }_{K ∈ {M}_{i} M} exp ( Leaky Re LU ( \vec{{XX}_{{M}_{i} {M}_{K}}} ) )} . \qquad ( 14 )$$

In formula (14), K represents any mention node in a mention node set MᵢM, and

$$\vec{{x}_{{M}_{i} {M}_{j}}}$$

represents an initial edge vector of a node edge MᵢMⱼ.

Operation S204: Generate, according to the initial node vectors respectively corresponding to the every two entity nodes, a predicted relationship corresponding to the every two entity nodes.

For example, the initial text recognition model includes an initial relationship prediction layer; and the every two entity nodes include a first entity node and a second entity node. An initial node vector corresponding to the first entity node and an initial node vector corresponding to the second entity node are concatenated by using the initial relationship prediction layer, to obtain a concatenated vector; and weighting processing is performed on the concatenated vector, to obtain a to-be-activated vector (also referred to as an “activation target vector”), and activation processing is performed on the to-be-activated vector, to obtain a predicted relationship corresponding to the first entity node and the second entity node.

The process may be expressed by the following formula (15):

$$x = soft max ( {W}_{c} \times concat ( \vec{{n}_{e 1}} , \vec{{n}_{{e}_{2}}} ) + {b}_{c} ) . \qquad ( 15 )$$

In formula (15),

$$\vec{{n}_{e 1}}$$

represents an initial node vector corresponding to the first entity node,

$$\vec{{n}_{{e}_{2}}}$$

represents an initial node vector corresponding to the second entity node, concat represents a concatenation function, soft max represents an activation function, and W_{c} and b_{c} represent adjustable parameters that are used for predicting an entity relationship and that are in the initial relationship prediction layer.

Operation S205: Generate, according to the tag entity word pair, a tag edge corresponding to the every two entity nodes.

For example, the every two entity nodes include a first entity node and a second entity node. Entity nodes respectively corresponding to two tag entity words in the tag entity word pair are determined as a first entity node pair; a second entity node pair including the first entity node and the second entity node is generated; and a positive sample tag edge is determined, if the first entity node pair includes an entity node pair that is the same as the second entity node pair, as a tag edge corresponding to the second entity node pair; or a negative sample tag edge is determined, if the first entity node pair includes no entity node pair that is the same as the second entity node pair, as a tag edge corresponding to the second entity node pair.

Operation S206: Generate an initial graph structure including at least two initial node vectors and the initial edge vector, and adjust a parameter in the initial text recognition model according to the predicted relationship corresponding to the every two entity nodes, the tag edge corresponding to the every two entity nodes, and the initial graph structure, to obtain a text recognition model; the text recognition model being configured for determining an entity word pair having the tag relationship in a text, and the parameter in the initial text recognition model including the general training parameter.

For example, a model loss value is determined according to the predicted relationship corresponding to the every two entity nodes and the tag edge corresponding to the every two entity nodes; and the parameter in the initial text recognition model is adjusted according to the model loss value and the initial graph structure, to obtain the text recognition model.

In embodiments of this application, the adjustable general training parameter is introduced for the associated node edge. Therefore, the extensibility of the initial text recognition model can be improved, that is, a processing effect of the initial text recognition model for different graph structures can be improved. In addition, in embodiments of this application, because the initial edge vector does not need to be inferred, fewer computing resources are consumed. In addition, because inferring the initial edge vector is avoided, a model parameter can be quickly updated, thereby improving efficiency of generating a text recognition model.

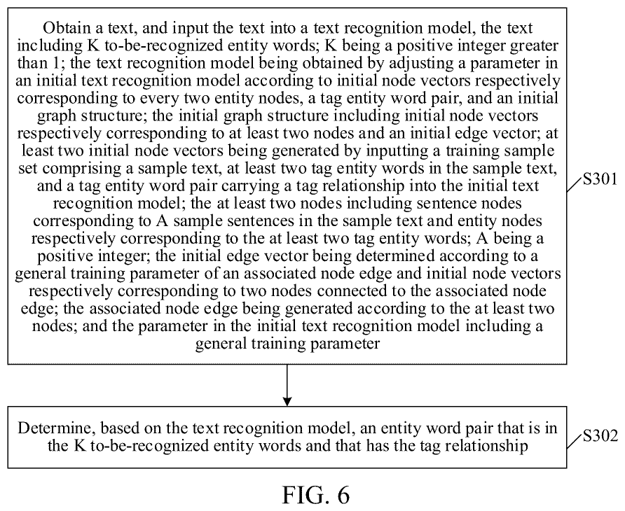

FIG. 6 is a third schematic flowchart of a data processing method according to an embodiment of this application. The method may be performed by a service server (for example, the service server 100 shown in FIG. 1), or may be performed by a terminal device (for example, the terminal device 200a shown in FIG. 1), or may be performed by interaction between a service server and a terminal device. For ease of understanding, in embodiments of this application, for example, the method is performed by a service server. As shown in FIG. 6, the method may include at least the following operations:

Operation S301: Obtain a text, and input the text into a text recognition model, the text including K to-be-recognized entity words (also referred to as “target entity words”); K being a positive integer greater than 1; the text recognition model being obtained by adjusting a parameter in an initial text recognition model according to initial node vectors respectively corresponding to every two entity nodes, a tag entity word pair, and an initial graph structure; the initial graph structure including initial node vectors respectively corresponding to at least two nodes and an initial edge vector; at least two initial node vectors being generated by inputting a training sample set including a sample text, at least two tag entity words in the sample text, and a tag entity word pair carrying a tag relationship into the initial text recognition model; the at least two nodes including sentence nodes corresponding to P sample sentences in the sample text and entity nodes respectively corresponding to the at least two tag entity words; P being a positive integer; the initial edge vector being determined according to a general training parameter of an associated node edge and initial node vectors respectively corresponding to two nodes connected by the associated node edge; the associated node edge being generated according to the at least two nodes; and the parameter in the initial text recognition model including the general training parameter.

For example, a text type and text content of the text are not limited in embodiments of this application. For example, the sample text may be an email text, a physical examination text, or a poem text. All data (for example, the text) mentioned in embodiments of this application is processed only after the granted permission is obtained.

In addition, for generation of the text recognition model, refer to the descriptions in the embodiments respectively corresponding to FIG. 4 and FIG. 5, and details are not described herein again.

Operation S302: Determine, based on the text recognition model, an entity word pair that is in the K to-be-recognized entity words and that has the tag relationship.

For example, the text recognition model includes a text encoding layer, a graph construction layer, and a relationship prediction layer. Encoded segmented word vectors respectively corresponding to Q segmented words in the text are generated by using the text encoding layer, and all the Q encoded segmented word vectors are inputted into the graph construction layer; where Q is a positive integer greater than 1. Entity nodes respectively corresponding to the K to-be-recognized entity words are constructed by using the graph construction layer, node vectors respectively corresponding to the K entity nodes are generated according to the Q encoded segmented word vectors, and all the K node vectors are inputted into the relationship prediction layer; where the K to-be-recognized entity words include a first to-be-recognized entity word and a second to-be-recognized entity word; and the K node vectors include a first node vector corresponding to the first to-be-recognized entity word and a second node vector corresponding to the second to-be-recognized entity word. The first node vector and the second node vector are concatenated by using the relationship prediction layer, to obtain a target concatenated vector. Weighting processing is performed on the target concatenated vector, to obtain a to-be-activated vector, and activation processing is performed on the to-be-activated vector, to obtain a target predicted relationship between the first to-be-recognized entity word and the second to-be-recognized entity word. The entity word pair having the tag relationship is generated according to the target predicted relationship corresponding to every two to-be-recognized entity words.

A process in which the service server determines the entity word pair based on the text recognition model is the same as a process in which the service server determines the predicted relationship between every two entity nodes based on the initial text recognition model. Therefore, details are not described herein again.

Model structures respectively corresponding to the text recognition model and the initial text recognition model are the same, and a difference lies only in that a model parameter of the latter needs to be adjusted, and a model parameter of the former has been adjusted. Similarly, a structure of the text encoding layer is the same as a structure of the initial text encoding layer, and a difference also lies only in parameter adjustment, a structure of the graph construction layer is the same as a structure of the initial graph construction layer, and a structure of the relationship prediction layer is the same as a structure of the initial relationship prediction layer.

As can be seen from above, in embodiments of this application, the adjustable general training parameter is introduced for the associated node edge. Therefore, the extensibility of the initial text recognition model can be improved, that is, a processing effect of the initial text recognition model for different graph structures can be improved. In addition, in embodiments of this application, because the initial edge vector does not need to be inferred, waste of computing resources can be reduced. In addition, because inferring the initial edge vector is avoided, a model parameter can be quickly updated, thereby improving efficiency of generating a text recognition model.

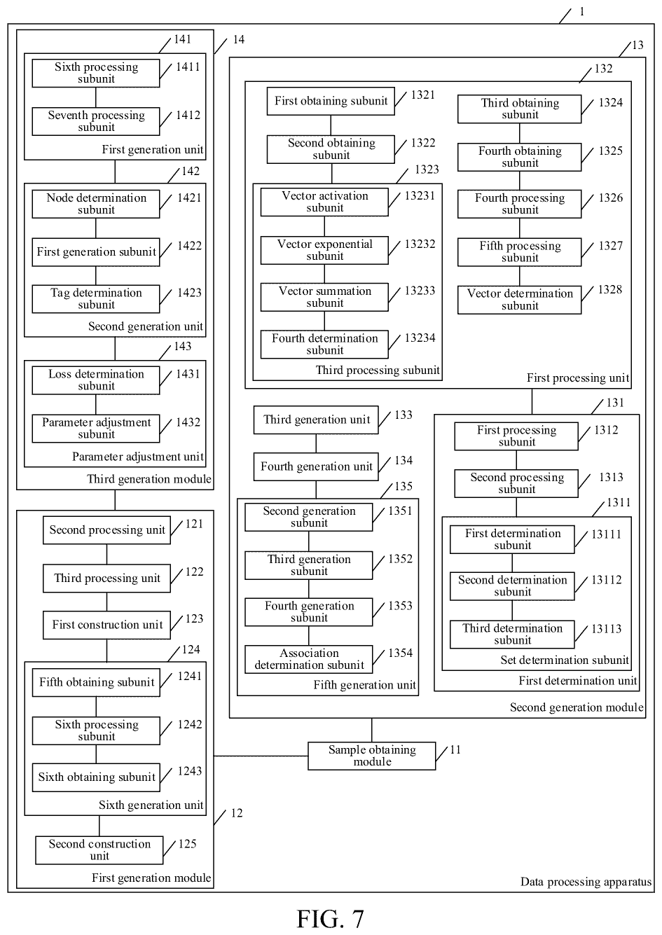

FIG. 7 is a first schematic structural diagram of a data processing apparatus according to an embodiment of this application. The data processing apparatus 1 may be configured to perform the corresponding operations in the method provided in the embodiments of this application. As shown in FIG. 7, the data processing apparatus 1 may include: a sample obtaining module 11, a first generation module 12, a second generation module 13, and a third generation module 14.

The sample obtaining module 11 is configured to obtain a training sample set; the training sample set including a sample text, at least two tag entity words in the sample text, and a tag entity word pair carrying a tag relationship.

The first generation module 12 is configured to input the training sample set into an initial text recognition model, to generate, based on the initial text recognition model, initial node vectors respectively corresponding to at least two nodes; the at least two nodes including sentence nodes corresponding to P sample sentences in the sample text and entity nodes respectively corresponding to the at least two tag entity words; and P being a positive integer.

The second generation module 13 is configured to generate an associated node edge according to the at least two nodes, and determine, according to a general training parameter of the associated node edge and initial node vectors respectively corresponding to two nodes connected by the associated node edge, an initial edge vector corresponding to the associated node edge.

The third generation module 14 is configured to generate an initial graph structure including at least two initial node vectors and the initial edge vector, and adjust a parameter in the initial text recognition model according to initial node vectors respectively corresponding to every two entity nodes, the tag entity word pair, and the initial graph structure, to obtain a text recognition model configured for determining an entity word pair having the tag relationship in a text; the parameter in the initial text recognition model including the general training parameter.

For specific implementations of functions of the sample obtaining module 11, the first generation module 12, the second generation module 13, and the third generation module 14, refer to operation S101 to operation S104 of the above corresponding embodiment in FIG. 4. Details are not described herein.

Referring to FIG. 7 again, the second generation module 13 may include: a vector determination unit 131 and a first processing unit 132.

The vector determination unit 131 is configured to determine, according to the general training parameter of the associated node edge and the initial node vectors respectively corresponding to the two nodes connected by the associated node edge, a to-be-normalized edge vector corresponding to the associated node edge.

The first processing unit 132 is configured to normalize the to-be-normalized edge vector corresponding to the associated node edge, to obtain the initial edge vector corresponding to the associated node edge.

For specific implementations of functions of the vector determination unit 131 and the first processing unit 132, refer to operation S103 of the above corresponding embodiment in FIG. 4. Details are not described herein.

Referring to FIG. 7 again, the vector determination unit 131 may include: a set determination subunit 1311, a first processing subunit 1312, and a second processing subunit 1313.

The set determination subunit 1311 is configured to determine, according to node types respectively corresponding to the two nodes connected by the associated node edge, the general training parameter and a to-be-processed vector set corresponding to the associated node edge; where the to-be-processed vector set includes the initial node vectors respectively corresponding to the two nodes connected by the associated node edge; and the general training parameter includes a general weight parameter and a general scaling parameter. The first processing subunit 1312 is configured to perform weighting processing on the to-be-processed vector set based on the general weight parameter, to obtain a weighted vector set. The second processing subunit 1313 is configured to concatenate weighted vectors in the weighted vector set, to obtain a to-be-scaled vector, and perform scaling processing on the to-be-scaled vector based on the general scaling parameter, to obtain the to-be-normalized edge vector corresponding to the associated node edge.

For specific implementations of functions of the set determination subunit 1311, the first processing subunit 1312, and the second processing subunit 1313, refer to operation S103 in the above corresponding embodiment in FIG. 4. Details are not described herein.

Referring to FIG. 7 again, the set determination subunit 1311 may include: a first determination subunit 13111, a second determination subunit 13112, and a third determination subunit 13113.

The first determination subunit 13111 is configured to determine, if the node types respectively corresponding to the two nodes connected by the associated node edge are different, a compound general training parameter as the general training parameter, and determine the initial node vectors respectively corresponding to the two nodes connected by the associated node edge as the to-be-processed vector set. The second determination subunit 13112 is configured to determine, if the node types respectively corresponding to the two nodes connected by the associated node edge are the same and the two nodes connected by the associated node edge both belong to P sentence nodes, a general sentence training parameter as the general training parameter, and determine the initial node vectors respectively corresponding to the two nodes connected by the associated node edge and a distance vector between the two nodes connected by the associated node edge as the to-be-processed vector set. The third determination subunit 13113 is configured to determine, if the node types respectively corresponding to the two nodes connected by the associated node edge are the same and the two nodes connected by the associated node edge both belong to a mention node set, a general mention training parameter as the general training parameter, and determine the initial node vectors respectively corresponding to the two nodes connected by the associated node edge, context vectors of the two nodes connected by the associated node edge, and a distance vector between the two nodes connected by the associated node edge as the to-be-processed vector set; where a tag mention word corresponding to a mention node in the mention node set belongs to the sample text.

For specific implementations of functions of the first determination subunit 13111, the second determination subunit 13112, and the third determination subunit 13113, refer to operation S103 in the above corresponding embodiment in FIG. 4. Details are not described herein.

Referring to FIG. 7 again, the associated node edge includes a first node edge; and two nodes connected by the first node edge include a first node and a second node. The first processing unit 132 may include: a first obtaining subunit 1321, a second obtaining subunit 1322, and a third processing subunit 1323.

The first obtaining subunit 1321 is configured to obtain a second node edge from the associated node edge if a node type corresponding to the first node is different from a node type corresponding to the second node; where if the first node belongs to at least two entity nodes and the second node belongs to the P sentence nodes, two nodes connected by the second node edge include the first node and a third node, and the third node belongs to the P sentence nodes; and if the first node belongs to the mention node set, two nodes connected by the second node edge include the first node and a fourth node, a node type corresponding to the fourth node is the same as the node type corresponding to the second node, and a tag mention word corresponding to a mention node in the mention node set belongs to the sample text.

The second obtaining subunit 1322 is configured to obtain a to-be-normalized edge vector corresponding to the second node edge from the to-be-normalized edge vector corresponding to the associated node edge. The third processing subunit 1323 is configured to normalize, based on the to-be-normalized edge vector corresponding to the second node edge, a to-be-normalized edge vector corresponding to the first node edge, to obtain an initial edge vector corresponding to the first node edge.

For specific implementations of functions of the first obtaining subunit 1321, the second obtaining subunit 1322, and the third processing subunit 1323, refer to operation S103 in the above corresponding embodiment in FIG. 4. Details are not described herein.

Referring to FIG. 7 again, the third processing subunit 1323 may include: a vector activation subunit 13231, a vector exponential subunit 13232, a vector summation subunit 13233, and a fourth determination subunit 13234.

The vector activation subunit 13231 is configured to perform activation processing on the to-be-normalized edge vector corresponding to the first node edge, to obtain an activated vector corresponding to the first node edge; and perform activation processing on the to-be-normalized edge vector corresponding to the second node edge, to obtain an activated vector corresponding to the second node edge. The vector exponential subunit 13232 is configured to perform exponential processing on the activated vector corresponding to the first node edge, to obtain an exponential vector corresponding to the first node edge, and perform exponential processing on the activated vector corresponding to the second node edge, to obtain exponential vectors corresponding to the second node edge. The vector summation subunit 13233 is configured to perform summation processing on the exponential vectors corresponding to the second node edge, to obtain a total exponential vector corresponding to the second node edge.

The fourth determination subunit 13234 is configured to determine a ratio of the exponential vector corresponding to the first node edge to the total exponential vector corresponding to the second node edge as the initial edge vector corresponding to the first node edge.

For specific implementations of functions of the vector activation subunit 13231, the vector exponential subunit 13232, the vector summation subunit 13233, and the fourth determination subunit 13234, refer to operation S103 in the above corresponding embodiment in FIG. 4. Details are not described herein.

Referring to FIG. 7 again, the associated node edge includes a third node edge; and two nodes connected by the third node edge include a fifth node and a sixth node. The first processing unit 132 may include: a third obtaining subunit 1324, a fourth obtaining subunit 1325, a fourth processing subunit 1326, a fifth processing subunit 1327, and a vector determination subunit 1328.

The third obtaining subunit 1324 is configured to obtain a fourth node edge and a fifth node edge from the associated node edge if a node type corresponding to the fifth node is the same as a node type corresponding to the sixth node; where if the fifth node and the sixth node both belong to the P sentence nodes, two nodes connected by the fourth node edge include the fifth node and a seventh node, and two nodes connected by the fifth node edge include the sixth node and an eighth node, and the seventh node and the eighth node both belong to the P sentence nodes; and if the fifth node and the sixth node both belong to the mention node set, two nodes connected by the fourth node edge include the fifth node and a ninth node, and two nodes connected by the fifth node edge include the sixth node and a tenth node, the ninth node and the tenth node both belong to the mention node set, and a tag mention word corresponding to a mention node in the mention node set belongs to the sample text. The fourth obtaining subunit 1325 is configured to obtain, from the to-be-normalized edge vector corresponding to the associated node edge, a to-be-normalized edge vector corresponding to the fourth node edge and a to-be-normalized edge vector corresponding to the fifth node edge. The fourth processing subunit 1326 is configured to normalize, based on the to-be-normalized edge vector corresponding to the fourth node edge, a to-be-normalized edge vector corresponding to the third node edge, to obtain a first initial edge vector corresponding to the third node edge. The fifth processing subunit 1327 is configured to normalize, based on the to-be-normalized edge vector corresponding to the fifth node edge, a to-be-normalized edge vector corresponding to the third node edge, to obtain a second initial edge vector corresponding to the third node edge. The vector determination subunit 1328 is configured to determine the first initial edge vector and the second initial edge vector as initial edge vectors corresponding to the third node edge.

For specific implementations of functions of the third obtaining subunit 1324, the fourth obtaining subunit 1325, the fourth processing subunit 1326, the fifth processing subunit 1327, and the vector determination subunit 1328, refer to operation S103 in the above corresponding embodiment in FIG. 4. Details are not described herein.

Referring to FIG. 7 again, the third generation module 14 may include: a first generation unit 141, a second generation unit 142, and a parameter adjustment unit 143.

The first generation unit 141 is configured to generate, according to the initial node vectors respectively corresponding to the every two entity nodes, a predicted relationship corresponding to the every two entity nodes. The second generation unit 142 is configured to generate, according to the tag entity word pair, a tag edge corresponding to the every two entity nodes. The parameter adjustment unit 143 is configured to adjust the parameter in the initial text recognition model according to the predicted relationship corresponding to the every two entity nodes, the tag edge corresponding to the every two entity nodes, and the initial graph structure, to obtain the text recognition model; where the text recognition model is configured for determining an entity word pair having the tag relationship in a text.

For specific implementations of functions of the first generation unit 141, the second generation unit 142, and the parameter adjustment unit 143, refer to operation S204 to operation S206 in the above corresponding embodiment in FIG. 5. Details are not described herein.

Referring to FIG. 7 again, the initial text recognition model includes an initial relationship prediction layer; and the every two entity nodes include a first entity node and a second entity node. The first generation unit 141 may include: a sixth processing subunit 1411 and a seventh processing subunit 1412.

The sixth processing subunit 1411 is configured to concatenate, by using the initial relationship prediction layer, an initial node vector corresponding to the first entity node and an initial node vector corresponding to the second entity node, to obtain a concatenated vector. The seventh processing subunit 1412 is configured to perform weighting processing on the concatenated vector, to obtain a to-be-activated vector, and perform activation processing on the to-be-activated vector, to obtain a predicted relationship corresponding to the first entity node and the second entity node.

For specific implementations of functions of the sixth processing subunit 1411 and the seventh processing subunit 1412, refer to operation S204 of the above corresponding embodiment in FIG. 5. Details are not described herein.

Referring to FIG. 7 again, the every two entity nodes include a first entity node and a second entity node.

The second generation unit 142 may include: a node determination subunit 1421, a first generation subunit 1422, and a tag determination subunit 1423.

The node determination subunit 1421 is configured to determine, as a first entity node pair, entity nodes respectively corresponding to two tag entity words in the tag entity word pair. The first generation subunit 1422 is configured to generate a second entity node pair including the first entity node and the second entity node. The tag determination subunit 1423 is configured to determine, if the first entity node pair includes an entity node pair that is the same as the second entity node pair, a positive sample tag edge as a tag edge corresponding to the second entity node pair. The tag determination subunit 1423 is further configured to determine, if the first entity node pair includes no entity node pair that is the same as the second entity node pair, a negative sample tag edge as a tag edge corresponding to the second entity node pair.

For specific implementations of functions of the node determination subunit 1421, the first generation subunit 1422, and the tag determination subunit 1423, refer to operation S205 in the above corresponding embodiment in FIG. 5. Details are not described herein.

Referring to FIG. 7 again, the parameter adjustment unit 143 may include: a loss determination subunit 1431 and a parameter adjustment subunit 1432.

The loss determination subunit 1431 is configured to determine a model loss value according to the predicted relationship corresponding to the every two entity nodes and the tag edge corresponding to the every two entity nodes. The parameter adjustment subunit 1432 is configured to adjust the parameter in the initial text recognition model according to the model loss value and the initial graph structure, to obtain the text recognition model.

For specific implementations of functions of the loss determination subunit 1431 and the parameter adjustment subunit 1432, refer to operation S206 of the above corresponding embodiment in FIG. 5. Details are not described herein.

Referring to FIG. 7 again, the at least two entity nodes include an entity node Hᵢ, i is a positive integer, and i is less than or equal to a total quantity of the at least two entity nodes. The second generation module 13 may include: a third generation unit 133, a fourth generation unit 134, and a fifth generation unit 135.

The third generation unit 133 is configured to obtain, from the P sentence nodes, a first associated sentence node associated with the entity node Hᵢ, and generate a first associated node edge including the entity node Hᵢ and the first associated sentence node; where a sample sentence corresponding to the first associated sentence node includes a tag entity word corresponding to the entity node Hᵢ. The fourth generation unit 134 is configured to generate a second associated node edge according to every two sentence nodes of the P sentence nodes if P is a positive integer greater than 1. The fifth generation unit 135 is configured to generate the associated node edge according to the first associated node edge and the second associated node edge.

For specific implementations of functions of the third generation unit 133, the fourth generation unit 134, and the fifth generation unit 135, refer to operation S103 in the above corresponding embodiment in FIG. 4. Details are not described herein.

Referring to FIG. 7 again, the at least two nodes include J mention nodes, J is a positive integer, and tag mention words corresponding to the J mention nodes belong to the sample text. The fifth generation unit 135 may include: a second generation subunit 1351, a third generation subunit 1352, a fourth generation subunit 1353, and an association determination subunit 1354.

The second generation subunit 1351 is configured to generate, if the J mention nodes include an associated mention node associated with the entity node Hᵢ, a third associated node edge including the associated mention node and the entity node Hᵢ; where a tag mention word corresponding to the associated mention node is a mention word of a tag entity word corresponding to the entity node Hᵢ. The third generation subunit 1352 is configured to obtain, from the P sentence nodes, a second associated sentence node associated with the associated mention node, and generate a fourth associated node edge including the associated mention node and the second associated sentence node; where a sample sentence corresponding to the second associated sentence node includes a tag mention word corresponding to the associated mention node. The fourth generation subunit 1353 is configured to generate, if J is a positive integer greater than 1 and the J mention nodes include an associated mention node pair, a fifth associated node edge including the associated mention node pair; where two tag mention words corresponding to the associated mention node pair are located in the same sample sentence. The association determination subunit 1354 is configured to determine the first associated node edge, the second associated node edge, the third associated node edge, the fourth associated node edge, and the fifth associated node edge as associated node edges.

For specific implementations of functions of the second generation subunit 1351, the third generation subunit 1352, the fourth generation subunit 1353, and the association determination subunit 1354, refer to operation S103 in the above corresponding embodiment in FIG. 4. Details are not described herein.

Referring to FIG. 7 again, the initial text recognition model includes an initial text encoding layer and an initial graph construction layer. The first generation module 12 may include: a second processing unit 121, a third processing unit 122, a first construction unit 123, and a sixth generation unit 124.

The second processing unit 121 is configured to perform segmentation processing on the sample text by using the initial text encoding layer, to obtain at least two segmented words, and perform vector conversion processing on the at least two segmented words, to generate initial segmented word vectors respectively corresponding to the at least two segmented words. The third processing unit 122 is configured to respectively perform encoding processing on the at least two initial segmented word vectors, to generate encoded segmented word vectors respectively corresponding to the at least two segmented words, and input all the at least two encoded segmented word vectors into the initial graph construction layer. The first construction unit 123 is configured to construct, by using the initial graph construction layer, entity nodes respectively corresponding to the at least two tag entity words and sentence nodes corresponding to the P sample sentences. The sixth generation unit 124 is configured to generate the at least two nodes according to the at least two entity nodes and the P sentence nodes, and generate, according to the at least two encoded segmented word vectors, the initial node vectors respectively corresponding to the at least two nodes.

For specific implementations of functions of the second processing unit 121, the third processing unit 122, the first construction unit 123, and the sixth generation unit 124, refer to operation S102 in the above corresponding embodiment in FIG. 4. Details are not described herein.

Referring to FIG. 7 again, the at least two tag entity words include a tag entity word C_{d}, d is a positive integer, and d is less than or equal to a total quantity of the at least two tag entity words. The first generation module 12 may further include: a second construction unit 125.

The second construction unit 125 is configured to construct, if the sample text includes a tag mention word E_{d} corresponding to the tag entity word C_{d}, a mention node corresponding to the tag mention word E_{d}. The sixth generation unit 124 is specifically configured to determine the at least two entity nodes, the P sentence nodes, and the mention node corresponding to the tag mention word E_{d} as the at least two nodes.

For specific implementations of functions of the second construction unit 125 and the sixth generation unit 124, refer to operation S102 of the above corresponding embodiment in FIG. 4. Details are not described herein.

Referring to FIG. 7 again, the at least two nodes include a node F_{g}; g is a positive integer, and g is less than or equal to a total quantity of the at least two nodes. The sixth generation unit 124 may include: a fifth obtaining subunit 1241, a sixth processing subunit 1242, and a sixth obtaining subunit 1243.

The fifth obtaining subunit 1241 is configured to: if the node F_{g} is used for representing a tag mention word E_{d}, obtain, from at least two segmented words, a first segmented word included in the tag mention word E_{d}, obtain, from the at least two encoded segmented word vectors, a first encoded segmented word vector corresponding to the first segmented word, and perform averaging processing on the first encoded segmented word vector, to obtain an initial node vector corresponding to the node F_{g}. The sixth processing subunit 1242 is configured to: if the node F_{g} is used for representing a tag entity word C_{d}, perform averaging processing on an initial node vector corresponding to a tag mention word E_{d}, to obtain an initial node vector corresponding to the node F_{g}. The sixth obtaining subunit 1243 is configured to: if the node F_{g} belongs to the P sentence nodes, obtain, from at least two segmented words, a second segmented word included in a sample sentence corresponding to the node F_{g}, obtain, from the at least two encoded segmented word vectors, a second encoded segmented word vector corresponding to the second segmented word, and perform averaging processing on the second encoded segmented word vector, to obtain an initial node vector corresponding to the node F_{g}.

For specific implementations of functions of the fifth obtaining subunit 1241, the sixth processing subunit 1242, and the sixth obtaining subunit 1243, refer to operation S102 in the above corresponding embodiment in FIG. 4. Details are not described herein.

As can be seen from above, in embodiments of this application, the adjustable general training parameter is introduced for the associated node edge. Therefore, the extensibility of the initial text recognition model can be improved, that is, a processing effect of the initial text recognition model for different graph structures can be improved. In addition, in embodiments of this application, because the initial edge vector does not need to be inferred, waste of computing resources can be reduced. In addition, because inferring the initial edge vector is avoided, a model parameter can be quickly updated, thereby improving efficiency of generating a text recognition model.

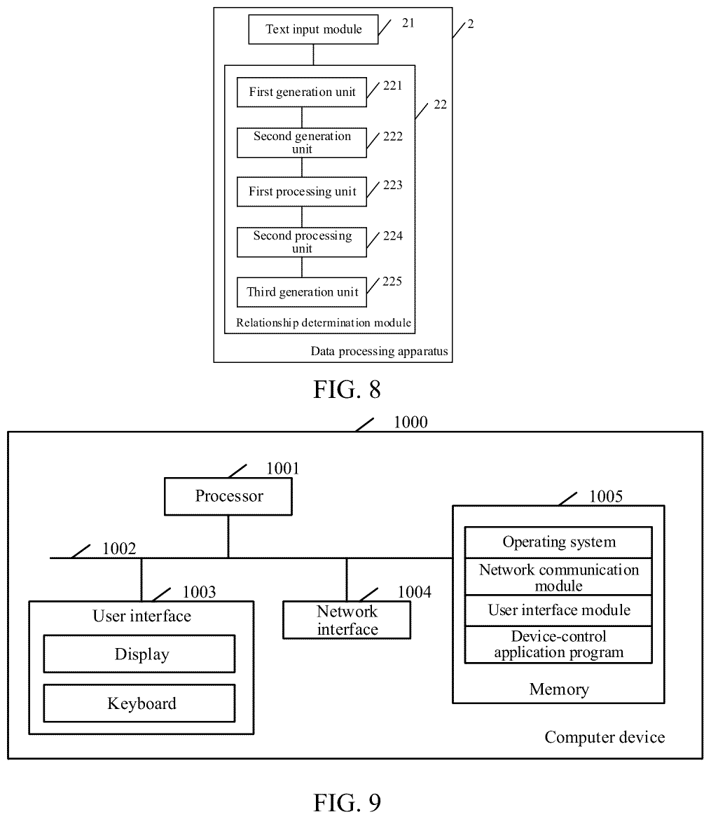

FIG. 8 is a second schematic structural diagram of a data processing apparatus according to an embodiment of this application. The data processing apparatus 2 may be configured to perform the corresponding operations in the method provided in the embodiments of this application. As shown in FIG. 8, the data processing apparatus 2 may include: a text input module 21 and a relationship determination module 22.

The text input module 21 is configured to obtain a text, and input the text to a text recognition model; the text including K to-be-recognized entity words; K is a positive integer greater than 1; the text recognition model being obtained by adjusting a parameter in an initial text recognition model according to initial node vectors respectively corresponding to every two entity nodes, a tag entity word pair, and an initial graph structure; the initial graph structure including initial node vectors respectively corresponding to at least two nodes and an initial edge vector; at least two initial node vectors being generated by inputting a training sample set including a sample text, at least two tag entity words in the sample text, and a tag entity word pair carrying a tag relationship into the initial text recognition model; the at least two nodes including sentence nodes corresponding to P sample sentences in the sample text and entity nodes respectively corresponding to the at least two tag entity words; P being a positive integer; the initial edge vector being determined according to a general training parameter of an associated node edge and initial node vectors respectively corresponding to two nodes connected by the associated node edge; the associated node edge being generated according to the at least two nodes; and the parameter in the initial text recognition model including the general training parameter.

The relationship determination module 22 is configured to determine, based on the text recognition model, an entity word pair that is in the K to-be-recognized entity words and that has the tag relationship.

For specific implementations of functions of the text input module 21 and the relationship determination module 22, refer to operation S301 and operation S302 of the above corresponding embodiment in FIG. 6. Details are not described herein.

Referring to FIG. 8 again, the text recognition model includes a text encoding layer, a graph construction layer, and a relationship prediction layer. The relationship determination module 22 may include: a first generation unit 221, a second generation unit 222, a first processing unit 223, a second processing unit 224, and a third generation unit 225.

The first generation unit 221 is configured to generate, by using the text encoding layer, encoded segmented word vectors respectively corresponding to Q segmented words in the text, and input all the Q encoded segmented word vectors into the graph construction layer; where Q is a positive integer greater than 1. The second generation unit 222 is configured to construct, by using the graph construction layer, entity nodes respectively corresponding to the K to-be-recognized entity words, generate, according to the Q encoded segmented word vectors, node vectors respectively corresponding to the K entity nodes, and input all the K node vectors into the relationship prediction layer; where the K to-be-recognized entity words include a first to-be-recognized entity word and a second to-be-recognized entity word; and the K node vectors include a first node vector corresponding to the first to-be-recognized entity word and a second node vector corresponding to the second to-be-recognized entity word. The first processing unit 223 is configured to concatenate the first node vector and the second node vector by using the relationship prediction layer, to obtain a target concatenated vector. The second processing unit 224 is configured to perform weighting processing on the target concatenated vector, to obtain a to-be-activated vector, and perform activation processing on the to-be-activated vector, to obtain a target predicted relationship between the first to-be-recognized entity word and the second to-be-recognized entity word. The third generation unit 225 is configured to generate, according to the target predicted relationship corresponding to every two to-be-recognized entity words, the entity word pair having the tag relationship.

For specific implementations of functions of the first generation unit 221, the second generation unit 222, the first processing unit 223, the second processing unit 224, and the third generation unit 225, refer to operation S302 in the above corresponding embodiment in FIG. 6. Details are not described herein.

As can be seen from above, in embodiments of this application, the adjustable general training parameter is introduced for the associated node edge. Therefore, the extensibility of the initial text recognition model can be improved, that is, a processing effect of the initial text recognition model for different graph structures can be improved. In addition, in embodiments of this application, because the initial edge vector does not need to be inferred, waste of computing resources can be reduced. In addition, because inferring the initial edge vector is avoided, a model parameter can be quickly updated, thereby improving efficiency of generating a text recognition model.

FIG. 9 is a schematic structural diagram of a computer device according to an embodiment of this application. As shown in FIG. 9, the computer device 1000 may include: at least one processor 1001, for example, a CPU, at least one network interface 1004, a user interface 1003, a memory 1005, and at least one communication bus 1002. The communication bus 1002 is configured to implement connection and communication between these components. In some embodiments, the user interface 1003 may include a display and a keyboard. In an embodiment, the network interface 1004 may include a standard wired interface and wireless interface (for example, a WI-FI interface). The memory 1005 may be a high-speed RAM memory, or may be a non-volatile memory, for example, at least one magnetic disk memory. In an embodiment, the memory 1005 may be at least one storage apparatus located remotely from the processor 1001. As shown in FIG. 9, the memory 1005 used as a computer storage medium may include an operating system, a network communications module, a user interface module, and a device-control application program.

In the computer device 1000 shown in FIG. 9, the network interface 1004 may provide a network communication function. The user interface 1003 is mainly configured to provide an input interface for a user. The processor 1001 may be configured to call the device-control application program stored in the memory 1005 to implement: obtaining a training sample set; the training sample set including a sample text, at least two tag entity words in the sample text, and a tag entity word pair carrying a tag relationship; inputting the training sample set into an initial text recognition model, to generate, based on the initial text recognition model, initial node vectors respectively corresponding to at least two nodes; the at least two nodes including sentence nodes corresponding to P sample sentences in the sample text and entity nodes respectively corresponding to the at least two tag entity words; and P being a positive integer; generating an associated node edge according to the at least two nodes, and determining, according to a general training parameter of the associated node edge and initial node vectors respectively corresponding to two nodes connected by the associated node edge, an initial edge vector corresponding to the associated node edge; and generating an initial graph structure including at least two initial node vectors and the initial edge vector, and adjusting a parameter in the initial text recognition model according to initial node vectors respectively corresponding to every two entity nodes, the tag entity word pair, and the initial graph structure, to obtain a text recognition model configured for determining an entity word pair having the tag relationship in a text; the parameter in the initial text recognition model including the general training parameter.

Alternatively, the processor 1001 may be configured to call the device-control application program stored in the memory 1005 to implement: obtaining a text, and inputting the text into a text recognition model; the text including K to-be-recognized entity words; K being a positive integer greater than 1; the text recognition model being obtained by adjusting a parameter in an initial text recognition model according to initial node vectors respectively corresponding to every two entity nodes, a tag entity word pair, and an initial graph structure; the initial graph structure including initial node vectors respectively corresponding to at least two nodes and an initial edge vector; at least two initial node vectors being generated by inputting a training sample set including a sample text, at least two tag entity words in the sample text, and a tag entity word pair carrying a tag relationship into the initial text recognition model; the at least two nodes including sentence nodes corresponding to P sample sentences in the sample text and entity nodes respectively corresponding to the at least two tag entity words; P being a positive integer; the initial edge vector being determined according to a general training parameter of an associated node edge and initial node vectors respectively corresponding to two nodes connected by the associated node edge; the associated node edge being generated according to the at least two nodes; and the parameter in the initial text recognition model including the general training parameter; and determining, based on the text recognition model, an entity word pair that is in the K to-be-recognized entity words and that has the tag relationship.

The computer device 1000 described in embodiments of this application can execute the descriptions of the data processing method or apparatus in the above embodiments. Details are not described again herein. In addition, the description of beneficial effects of the same method are not described herein again.

An embodiment of this application further provides a computer-readable storage medium. The computer-readable storage medium stores a computer program. When the computer program is executed by a processor, the descriptions of the data processing method or apparatus in the above embodiments are implemented. Details are not described again herein. In addition, the description of beneficial effects of the same method are not described herein again.

The computer-readable storage medium may be the data processing apparatus in any one of the above embodiments or an internal storage unit of the computer device, such as a hard disk or a memory of the computer device. The computer-readable storage medium may also be an external storage device of the computer device, such as a plug-in hard disk equipped on the computer device, a smart media card (SMC), a secure digital (SD) card, a flash card, or the like. The computer-readable storage medium may also include both the internal storage unit and the external storage device of the computer device. The computer-readable storage medium is configured to store the computer program and other programs and data required by the computer device. The computer-readable storage medium can also be configured to temporarily store data that has been outputted or will be outputted.

An embodiment of this application further provides a computer program product, including a computer program, stored in a computer-readable storage medium. A processor of a computer device reads the computer program from the computer-readable storage medium, and the processor executes the computer program, so that the computer device can execute the descriptions of the data processing method or apparatus in the above embodiments. Details are not described again herein. In addition, the description of beneficial effects of the same method are not described herein again.

In the specification and claims and the accompanying drawings of the embodiments of this application, the terms such as “first” and “second” are used to distinguish between different objects, but are not used to describe a particular sequence of the objects. In addition, the term “include” and any variant thereof are intended to cover a non-exclusive inclusion. For example, a process, a method, an apparatus, a product, or a device that includes a series of operations or units is not limited to the listed operations or modules; and instead, in some embodiments, further includes an operation or a module that is not listed, or in some embodiments, further includes another operation or unit that is intrinsic to the process, the method, the apparatus, the product, or the device.

A person of ordinary skill in the art may be aware that, in combination with the examples described in the embodiments disclosed in this specification, units and algorithm operations may be implemented by electronic hardware, computer software, or a combination thereof. To clearly describe the interchangeability between the hardware and the software, the foregoing has generally described compositions and operations of each example according to functions. Whether the functions are executed in a mode of hardware or software depends on particular applications and design constraint conditions of the technical solutions. A person skilled in the art can use different methods to implement the described functions for each particular application, but it is not considered that the implementation goes beyond the scope of this application.

What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. A data processing method comprising:
obtaining a training sample set, the training sample set including a sample text, at least two tag entity words in the sample text, and a tag entity word pair carrying a tag relationship;
inputting the training sample set into an initial text recognition model, to generate, based on the initial text recognition model, initial node vectors respectively corresponding to at least two nodes, the at least two nodes including sentence nodes corresponding to P sample sentences in the sample text and entity nodes respectively corresponding to the at least two tag entity words, and P being a positive integer;
generating an associated node edge according to the at least two nodes, and determining, according to a general training parameter of the associated node edge and initial node vectors respectively corresponding to two connected nodes connected by the associated node edge, an initial edge vector corresponding to the associated node edge; and
generating an initial graph structure including at least two initial node vectors and the initial edge vector, and adjusting a parameter in the initial text recognition model according to initial node vectors respectively corresponding to every two entity nodes, the tag entity word pair, and the initial graph structure, to obtain a text recognition model configured for determining an entity word pair having the tag relationship in a text, the parameter in the initial text recognition model including the general training parameter.

2. The method according to claim 1, wherein determining the initial edge vector includes:
determining, according to the general training parameter and the initial node vectors, a target edge vector corresponding to the associated node edge; and
normalizing the target edge vector to obtain the initial edge vector.

3. The method according to claim 2, wherein determining the target edge vector includes:
determining, according to node types respectively corresponding to the two connected nodes, the general training parameter and a target vector set corresponding to the associated node edge, the target vector set including the initial node vectors, and the general training parameter including a general weight parameter and a general scaling parameter;
performing weighting processing on the target vector set based on the general weight parameter, to obtain a weighted vector set; and
concatenating weighted vectors in the weighted vector set, to obtain an activation target vector, and performing scaling processing on the activation target vector based on the general scaling parameter, to obtain the target edge vector.

4. The method according to claim 3, wherein determining the general training parameter and the target vector set includes:
in response to the node types respectively corresponding to the two connected nodes being different, determining a compound general training parameter as the general training parameter, and determining the initial node vectors as the target vector set;
in response to the node types respectively corresponding to the two connected nodes being same and the two connected nodes both belonging to P sentence nodes, determining a general sentence training parameter as the general training parameter, and determining the initial node vectors and a distance vector between the two connected nodes as the target vector set; or
in response to the node types respectively corresponding to the two connected nodes being same and the two connected nodes both belonging to a mention node set, determining a general mention training parameter as the general training parameter, and determining the initial node vectors, context vectors of the two connected nodes, and a distance vector between the two connected nodes as the target vector set, a tag mention word corresponding to a mention node in the mention node set belonging to the sample text.

5. The method according to claim 2, wherein:
the associated node edge is a first node edge in a plurality of associated node edges, the two connected nodes includes a first node and a second node, and the target edge vector corresponds to the first node edge and is one of a plurality of target edge vectors corresponding to the plurality of associated node edges; and
normalizing the target edge vector includes:
obtaining a second node edge from the plurality of associated node edge in response to a node type corresponding to the first node being different from a node type corresponding to the second node, the second node edge connecting:
the first node and a third node in response to the first node belonging to at least two entity nodes and the second node belonging to the P sentence nodes, the third node belonging to the P sentence nodes; or
the first node and a fourth node in response to the first node belonging to a mention node set, a node type corresponding to the fourth node being same as the node type corresponding to the second node, and a tag mention word corresponding to a mention node in the mention node set belonging to the sample text;
obtaining a target edge vector corresponding to the second node edge from the plurality of target edge vectors corresponding to the plurality of associated node edges; and
normalizing, based on the target edge vector corresponding to the second node edge, the target edge vector corresponding to the first node edge, to obtain an initial edge vector corresponding to the first node edge.

6. The method according to claim 5, wherein normalizing the target edge vector corresponding to the first node edge to obtain the initial edge vector corresponding to the first node edge includes:
performing activation processing on the target edge vector corresponding to the first node edge, to obtain an activated vector corresponding to the first node edge;
performing activation processing on the target edge vector corresponding to the second node edge, to obtain an activated vector corresponding to the second node edge;
performing exponential processing on the activated vector corresponding to the first node edge, to obtain an exponential vector corresponding to the first node edge;
performing exponential processing on the activated vector corresponding to the second node edge, to obtain exponential vectors corresponding to the second node edge;
performing summation processing on the exponential vectors corresponding to the second node edge, to obtain a total exponential vector corresponding to the second node edge; and
determining a ratio of the exponential vector corresponding to the first node edge to the total exponential vector corresponding to the second node edge as the initial edge vector corresponding to the first node edge.

7. The method according to claim 2, wherein:
the associated node edge is a first node edge in a plurality of associated node edges, the two connected nodes include a first node and a second node, and the target edge vector corresponds to the first node edge and is one of a plurality of target edge vectors corresponding to the plurality of associated node edges; and
normalizing the target edge vector includes:
obtaining a second node edge and a third node edge from the associated node edge in response to a node type corresponding to the first node being same as a node type corresponding to the second node, wherein:
the first node and the second node both belong to the P sentence nodes, the second node edge connects the first node and a third node, and the third node edge connects the second node and a fourth node, the third node and the fourth node both belonging to the P sentence nodes; or
the first node and the second node both belong to a mention node set, the second node edge connecting the first node and a fifth node, and the third node edge connecting the second node and a sixth node, the fifth node and the sixth node both belonging to the mention node set, and a tag mention word corresponding to a mention node in the mention node set belonging to the sample text;
obtaining, from the plurality of target edge vectors, a target edge vector corresponding to the second node edge and a target edge vector corresponding to the third node edge;
normalizing, based on the target edge vector corresponding to the second node edge, the target edge vector corresponding to the first node edge, to obtain a first initial edge vector corresponding to the first node edge;
normalizing, based on the target edge vector corresponding to the third node edge, the target edge vector corresponding to the first node edge, to obtain a second initial edge vector corresponding to the first node edge; and
determining the first initial edge vector and the second initial edge vector as initial edge vectors corresponding to the first node edge.

8. The method according to claim 1, wherein adjusting the parameter in the initial text recognition model includes:
generating, according to the initial node vectors, a predicted relationship corresponding to the every two entity nodes;
generating, according to the tag entity word pair, a tag edge corresponding to the every two entity nodes; and
adjusting the parameter in the initial text recognition model according to the predicted relationship, the tag edge, and the initial graph structure, to obtain the text recognition model.

9. The method according to claim 8, wherein:
the initial text recognition model includes an initial relationship prediction layer, and the every two entity nodes include a first entity node and a second entity node; and
generating the predicted relationship includes:
concatenating, using the initial relationship prediction layer, an initial node vector corresponding to the first entity node and an initial node vector corresponding to the second entity node, to obtain a concatenated vector;
performing weighting processing on the concatenated vector, to obtain an activation target vector; and
performing activation processing on the activation target vector, to obtain a predicted relationship corresponding to the first entity node and the second entity node.

10. The method according to claim 8, wherein:
the every two entity nodes include a first entity node and a second entity node; and
generating the tag edge includes:
determining, as one of one or more first entity node pairs, entity nodes respectively corresponding to two tag entity words in the tag entity word pair;
generating a second entity node pair including the first entity node and the second entity node; and
generating the tag edge based on the first entity node pair and the second entity node pair, including:
determining, in response to the one or more first entity node pairs including an entity node pair that is same as the second entity node pair, a positive sample tag edge as a tag edge corresponding to the second entity node pair; or
determining, in response to the one or more first entity node pairs including no entity node pair that is same as the second entity node pair, a negative sample tag edge as the tag edge corresponding to the second entity node pair.

11. The method according to claim 8, wherein adjusting the parameter in the initial text recognition model includes:
determining a model loss value according to the predicted relationship and the tag edge; and
adjusting the parameter in the initial text recognition model according to the model loss value and the initial graph structure, to obtain the text recognition model.

12. The method according to claim 1, wherein:
at least two entity nodes include an entity node Hᵢ, i is a positive integer, and i is less than or equal to a total quantity of the at least two entity nodes; and
generating the associated node edge includes generating a plurality of associated node edges, including:
obtaining, from the P sentence nodes, a first associated sentence node associated with the entity node Hᵢ, and generating a first associated node edge including the entity node Hᵢ and the first associated sentence node, a sample sentence corresponding to the first associated sentence node including a tag entity word corresponding to the entity node Hᵢ;
generating a second associated node edge according to every two sentence nodes of the P sentence nodes in response to P being a positive integer greater than 1; and
generating the plurality of associated node edges according to the first associated node edge and the second associated node edge.

13. The method according to claim 12, wherein:
the at least two nodes include J mention nodes, J is a positive integer, and tag mention words corresponding to the J mention nodes belong to the sample text; and
generating the plurality of associated node edges according to the first associated node edge and the second associated node edge includes:
generating, in response to the J mention nodes including an associated mention node associated with the entity node Hᵢ, a third associated node edge including the associated mention node and the entity node Hᵢ, a tag mention word corresponding to the associated mention node being a mention word of a tag entity word corresponding to the entity node Hᵢ;
obtaining, from the P sentence nodes, a second associated sentence node associated with the associated mention node, and generating a fourth associated node edge including the associated mention node and the second associated sentence node, a sample sentence corresponding to the second associated sentence node including a tag mention word corresponding to the associated mention node;
generating, in response to J being a positive integer greater than 1 and the J mention nodes including an associated mention node pair, a fifth associated node edge including the associated mention node pair, two tag mention words corresponding to the associated mention node pair being located in the same sample sentence; and
determining the first associated node edge, the second associated node edge, the third associated node edge, the fourth associated node edge, and the fifth associated node edge as ones of the plurality of associated node edges.

14. The method according to claim 1, wherein:
the initial text recognition model includes an initial text encoding layer and an initial graph construction layer; and
generating the initial node vectors includes:
performing segmentation processing on the sample text by using the initial text encoding layer, to obtain at least two segmented words, and performing vector conversion processing on the at least two segmented words, to generate initial segmented word vectors respectively corresponding to the at least two segmented words;
respectively performing encoding processing on the at least two initial segmented word vectors, to generate encoded segmented word vectors respectively corresponding to the at least two segmented words, and inputting all the at least two encoded segmented word vectors into the initial graph construction layer;
constructing, by using the initial graph construction layer, entity nodes respectively corresponding to the at least two tag entity words and sentence nodes corresponding to the P sample sentences; and
generating the at least two nodes according to the at least two entity nodes and the P sentence nodes, and generating, according to the at least two encoded segmented word vectors, the initial node vectors.

15. The method according to claim 14,
wherein the at least two tag entity words include a tag entity word C_{d}, d is a positive integer, and d is less than or equal to a total quantity of the at least two tag entity words;
the method further comprising:
constructing, in response to the sample text including a tag mention word E_{d}corresponding to the tag entity word C_{d}, a mention node corresponding to the tag mention word E_{d};
wherein generating the at least two nodes includes:
determining the at least two entity nodes, the P sentence nodes, and the mention node corresponding to the tag mention word E_{d} as the at least two nodes.

16. Anon-transitory computer-readable storage medium storing a computer program stored that, when executed by a processor, causes a computer device having the processor to perform the method according to claim 1.

17. A data processing method comprising:
obtaining a text including K target entity words, K being a positive integer greater than 1;
inputting the text into a text recognition model, the text recognition model being obtained by adjusting a parameter in an initial text recognition model according to initial node vectors respectively corresponding to every two entity nodes, a tag entity word pair, and an initial graph structure, the initial graph structure including initial node vectors respectively corresponding to at least two nodes and an initial edge vector, at least two initial node vectors being generated by inputting a training sample set including a sample text, at least two tag entity words in the sample text, and a tag entity word pair carrying a tag relationship into the initial text recognition model, the at least two nodes including sentence nodes corresponding to P sample sentences in the sample text and entity nodes respectively corresponding to the at least two tag entity words, P being a positive integer, the initial edge vector being determined according to a general training parameter of an associated node edge and initial node vectors respectively corresponding to two connected nodes connected by the associated node edge, the associated node edge being generated according to the at least two nodes, and the parameter in the initial text recognition model including the general training parameter; and
determining, based on the text recognition model, an entity word pair that is in the K target entity words and that has the tag relationship.

18. The method according to claim 17, wherein:
the text recognition model includes a text encoding layer, a graph construction layer, and a relationship prediction layer; and
determining the entity word pair includes:
generating, by using the text encoding layer, encoded segmented word vectors respectively corresponding to Q segmented words in the text, and inputting all the Q encoded segmented word vectors into the graph construction layer, Q being a positive integer greater than 1;
constructing, by using the graph construction layer, entity nodes respectively corresponding to the K target entity words, generating, according to the Q encoded segmented word vectors, node vectors respectively corresponding to the K entity nodes, and inputting all the K node vectors into the relationship prediction layer, the K target entity words including a first target entity word and a second target entity word, and the K node vectors including a first node vector corresponding to the first target entity word and a second node vector corresponding to the second target entity word;
concatenating the first node vector and the second node vector by using the relationship prediction layer, to obtain a target concatenated vector;
performing weighting processing on the target concatenated vector, to obtain an activation target vector, and performing activation processing on the activation target vector, to obtain a target predicted relationship between the first target entity word and the second target entity word; and
generating, according to the target predicted relationship corresponding to every two target entity words, the entity word pair having the tag relationship.

19. A computer device comprising:
a processor; and
a memory storing a computer program that, when executed by the processor, causes the computer device to perform the method according to claim 17.

20. A computer device comprising:
a processor; and
a memory storing a computer program that, when executed by the processor, causes the computer device to.
obtain a training sample set, the training sample set including a sample text, at least two tag entity words in the sample text, and a tag entity word pair carrying a tag relationship;
input the training sample set into an initial text recognition model, to generate, based on the initial text recognition model, initial node vectors respectively corresponding to at least two nodes, the at least two nodes including sentence nodes corresponding to P sample sentences in the sample text and entity nodes respectively corresponding to the at least two tag entity words, and P being a positive integer;
generate an associated node edge according to the at least two nodes, and determine, according to a general training parameter of the associated node edge and initial node vectors respectively corresponding to two connected nodes connected by the associated node edge, an initial edge vector corresponding to the associated node edge; and
generate an initial graph structure including at least two initial node vectors and the initial edge vector, and adjust a parameter in the initial text recognition model according to initial node vectors respectively corresponding to every two entity nodes, the tag entity word pair, and the initial graph structure, to obtain a text recognition model configured for determining an entity word pair having the tag relationship in a text, the parameter in the initial text recognition model including the general training parameter.
